(19) United States
(12) Patent Application Publication
(10) Pub. No.: US 2024/0285116 A1
(43) Pub. Date: Aug. 29, 2024

(54) DEVICE FOR OPENING CAPSULES FOR BEVERAGES, MACHINE FOR SUPPLYING A BEVERAGE AND ASSOCIATED METHODS

(71) Applicant: 77 VISION WAY LTD, Belfast, Antrim (GB)

(72) Inventors: Gianpaolo TRIVELLI, Pavia (IT); Gianluigi TRIVELLI, Pavia (IT); Mauro GAZZELLI, Lugano-Aldesago (CH); Claudio RAGGI, Terni (IT)

(21) Appl. No.: 18/563,478

(22) PCT Filed: May 25, 2022
(86) PCT No.: PCT/IB2022/054876

§ 371 Date: Nov. 22, 2023

(30) Foreign Application Priority Data
May 25, 2021 (IT) 102021000013628

(51) Int. Cl. A47J 31/40; A47J 31/44

(52) U.S. Cl. CPC A47J 31/407; A47J 31/4492

(57) ABSTRACT

A device for opening capsules for beverages, the opening device comprising:
at least a perforator configured to perforate at least one between a head portion, a bottom portion or a lateral wall of the capsule for beverages, realizing an opening such as to put an inner cavity of said capsule for beverages, within which is contained a substance (S) under pressure, in substantial communication with an outer environment,
at least a striker configured to retain the capsule for beverages in a predetermined position,
wherein
the device for opening capsules is configured to vary a relative position between the capsule for beverages and the perforator at least between a first position wherein the perforator is positioned at a distance from the capsule for beverages and a second position wherein the perforator is positioned at least partially within said capsule for beverages, protruding itself inside the inner cavity,
said device for opening capsules for beverages comprising a conveyor positioned in substantial correspondence of the perforator to realize a seal in substantial correspondence of said opening and configured to convey at least part of the substance (S) along a predetermined direction or path of injection of the substance (S) in a container for a beverage, such as to discharge the pressure present in the inner cavity of the capsule for beverages toward said predetermined direction or path of injection.

### TECHNICAL FIELD

The present disclosure refers to the field of supplying and/or dispensing capsules through beverages.

In detail the present disclosure refers to a device for opening capsules for beverages, a machine for supplying a beverage and also refers to their associated methods.

### BACKGROUND ART

There are known capsules for beverages typically configured to contain substantially granular substances and, thus, in substantially solid form. Typically, such capsules for beverages are realized in substantially plastic, or at least partially plastic, material.

Capsules of known type are mainly conceived for the purpose of dispensing coffee or tea or herbal teas. For this reason, they are typically provided with a film, realized in aluminum and/or plastic material, suitable to be perforated by a perforator. The purpose of the perforator is to allow the injection of water into the capsule.

Capsules of known type are provided with an outlet, typically placed in an opposite position with respect to the portion where the film is present. The outlet is in use positioned at the bottom, and this allows to outflow the water at least partially by gravity. The water injected with the perforator is made to flow through the granular substance and is therefore impregnated with the latter.

The Applicant observes that the capsules of known type are mainly conceived to extract a beverage by injection, infusion or percolation of a fluid injected from outside into the capsule. Capsules of known type, in particular those known for the dispensing of fluids such as coffee or herbal teas, are ill-suited for applications where the substance contained therein must be extracted in use.

The Applicant furthermore observes that nowadays, for the producer of capsules for beverages it is not possible to know how many capsules have actually been used and/or whether at least some of the capsules for beverages have been reused, in particular refilled again after a first use.

Devices for opening capsules for beverages of known type therefore comprise a perforator and a water injector within the capsule, which allow to place the capsule temporarily under slight pressure to allow the water to flow into the granular substance.

### PURPOSES

A purpose of the present disclosure is to describe a device for opening capsules for beverages of innovative type. It is in particular a purpose of the present disclosure to describe a device for opening capsules which allows to discharge effectively and/or safely any pressure that can be present in the capsule for beverages.

It is also a purpose of the present disclosure to describe a device for opening capsules for beverages which is easy to realize.

It is another purpose of the present disclosure to describe a device for opening capsules for beverages which is solid.

It is another purpose of the present disclosure to describe a method for opening capsules for beverages of innovative type. It is in particular a purpose of the present disclosure to describe a method for opening capsules for beverages which allows to discharge effectively and/or safely any pressure that can be present in the capsule for beverages.

It is also a purpose of the present disclosure to describe a method for opening capsules for beverages which allows to open effectively the capsule.

It is another purpose of the present disclosure to describe a method for opening capsules for beverages which allows to open the capsule even if the capsule is particularly solid.

It is another purpose of the present disclosure to describe a machine for supplying a beverage and a process for supplying a beverage, which, by using the device for opening capsules for beverages and the method described therein, advantageously allow the supply of a beverage added with a substance contained in the capsules for beverages in an efficient, safe, cost-effective manner.

It is another purpose of the present disclosure to describe a machine for supplying a beverage and a process for supplying a beverage with which it is possible to keep track of the capsules used for supplying the beverage

It is another purpose of the present disclosure to describe a machine for supplying a beverage and a process for supplying a beverage with which it is possible to supply a beverage whose characteristics are determined—at least partially—by the substance contained in the capsule for beverages and/or by the capsule for the beverage itself.

### SUMMARY

The object of the present disclosure is now described with reference to one or more main aspects, which are listed hereinafter.

These aspects can be combined with each other, and can also be combined with portions of the detailed description.

### Capsule

According to the present disclosure it is described a capsule (100), in particular a capsule (100) for beverages, comprising a lateral wall (101), a head portion (102), and a bottom portion (103), the head portion (102) and the bottom portion (103) being joined to the lateral wall (101),
wherein said lateral wall (101), said head portion (102) and said bottom portion (103) define an inner cavity (100c) in use insulated from the outer environment and configured to contain, in use, a substance at least partially fluid and/or powdery, in particular destined to produce a beverage in the form of additivated liquid the substance thereof represents a determined part in weight,
wherein said capsule (100) for beverages is configured to support within said inner cavity (100c) a predetermined pressure produced by said substance,
and wherein at least one among said head portion (102) and/or said bottom portion (103) and/or said lateral wall (101) comprises an opening portion configured to be perforated by a perforator (202) of a device for opening capsules (300) determining an opening of the inner cavity (100c) destined to cause an outflow of the substance, said outflow being at least partially produced by the pressure within said inner cavity (100c).

According to another non-limiting aspect, the capsule comprises an opening (102c) configured to be in use closed determining an insulation of the inner cavity (100c) from the outer environment.

According to another non-limiting aspect, the head portion (102) is a portion defining an opening (102c).

According to another non-limiting aspect, the opening (102c) is configured to allow an introduction of said substance within said inner cavity (100c) and is closed by means of at least a welding and/or folding and/or crimping and/or gluing operation destined to seal the opening (102c) for allowing an insulation of the inner cavity (100c) from the outer environment.

According to another non-limiting aspect, said insulation is sufficient to determine a maintenance of the predetermined pressure.

According to another non-limiting aspect, at least one among the lateral wall (101), the head portion (102) or the bottom portion (103) is realized in metallic material, optionally said lateral wall (101), said head portion (102) and said bottom portion (103) being realized in metallic material, optionally integrally in metallic material.

According to another non-limiting aspect, the lateral wall (101) comprises a first portion, in particular a first ending portion, and comprises a second portion, in particular a second ending portion,
the first portion of the lateral wall (101) being directly joined to said head portion (102),
the second portion of the lateral wall (101) being directly joined to said bottom portion (103).

According to another non-limiting aspect, the lateral wall (101), the head portion (102) and the bottom portion (103) are realized as a single piece, and/or are integral and/or are obtained from a single sheet of metallic material, optionally by means of folding and/or deformation.

According to another non-limiting aspect, at least the lateral wall (101) and the head portion (102) or the lateral wall (101) and the bottom portion (103) or the lateral wall (101), the head portion (102) and the bottom portion (103) are realized as a single piece of material, optionally being realized as a single piece of metallic sheet.

According to another non-limiting aspect, the capsule (100) for beverages comprises said substance.

According to another non-limiting aspect, the lateral wall (101) is joined by means of a welding and/or folding and/or crimping and/or gluing process to the head portion (102) and/or to the bottom portion (103).

According to another non-limiting aspect, the capsule (100) for beverages is configured to withstand at an inner pressure at least equal to 100 bar, or at least equal to 150 bar, or at least equal to 200 bar.

According to another non-limiting aspect, the lateral wall (101) comprises a tapered portion (101t).

According to another non-limiting aspect, the tapered portion (101t) lies in substantial correspondence of said head portion (102).

According to another non-limiting aspect, the tapered portion (101t) presents a transversal section gradually reducing towards said head portion (102).

According to another non-limiting aspect, the lateral wall (101) detects a substantially circular transversal section, and/or is substantially with tubular profile.

According to another non-limiting aspect, the head wall (102) is substantially planar and/or comprises a substantially planar wall.

According to another non-limiting aspect, the bottom portion (103) presents a substantially planar wall or presents at least a perimeter ring (103r) substantially developing itself on a plane and/or detecting a transversal section higher with respect to a transversal section detected by the lateral wall (101) and/or protruding outwards with respect to said lateral wall (101).

According to another non-limiting aspect, the capsule (100) for beverages comprises a longitudinal axis (A) passing through the inner cavity (100c), the longitudinal axis (A) being substantially orthogonal with respect to at least part of the, preferably all the, bottom portion (103) and/or being the axis around which said lateral wall (101) develops.

According to another non-limiting aspect, the bottom portion (103) presents a concave portion (103c) protruding within said inner cavity (100c).

According to another non-limiting aspect, the concave portion (103c) is inside said perimeter ring (103r).

According to another non-limiting aspect, said perimeter ring (103r) is configured to be engaged by a pusher (203), in particular by a movable and/or rotating pusher (203).

According to another non-limiting aspect, said perimeter ring (103r) comprises a front wall (103f) facing the lateral wall (101) and/or oblique with respect to said lateral wall (101), optionally orthogonal with respect to said lateral wall (101).

According to another non-limiting aspect, said perimeter ring (103r) comprises a rear wall (103p).

According to another non-limiting aspect, said rear wall (103p) is substantially oblique with respect to said lateral wall (101), and optionally is substantially orthogonal with respect to said lateral wall (101).

According to another non-limiting aspect, said rear wall (103p) is substantially parallel to said front wall (103f).

According to another non-limiting aspect, said front wall (103f) is a substantially annular wall and/or detects a substantially annular profile projecting outwards with respect to the lateral wall (101).

According to another non-limiting aspect, the bottom portion (103) comprises a substantially planar section.

According to another non-limiting aspect said pressure is a pressure lower than 0.5 bar and/or is a pressure lower than the limits given by the European rule “Pressure Equipment Device” 2014/68/UE.

According to another non-limiting aspect, said substance is a substance configured to generate said pressure when contained in said inner cavity (100c).

According to another non-limiting aspect, said substance is a substance configured to generate said pressure by state transformation.

According to another non-limiting aspect, said substance comprises an at least partially powdery substance, optionally a mineralization mix, configured to cause a water mineralization, in particular a water mineralization for human consumption.

According to another non-limiting aspect, said mineralization mix comprises at least one among magnesium carbonate or bicarbonate and/or calcium carbonate or bicarbonate and/or comprises at least one among magnesium, potassium, calcium, fluorine, iron, sodium, sulphur, silicon minerals.

According to another non-limiting aspect, said substance comprises a solvent, in particular water (2200), in particular distilled water (K).

According to another non-limiting aspect, said substance comprises a cooled and/or cooling and/or originally cooled material (2100), optionally dry ice or solid carbon dioxide, destined to cause a gas formation, optionally carbon-dioxide gas, by state transformation, and/or comprises a gas, optionally carbon-dioxide gas, said gas optionally deriving from a state transformation of a cooled and/or cooling and/or originally cooled material (2100), optionally deriving from a state transformation of dry ice or solid carbon dioxide.

According to another non-limiting aspect, the capsule (100) for beverages comprises at least an identification device, in particular an electronic tag and/or a radiofrequency identification circuit (119i).

According to another non-limiting aspect, the at least an identification device, in particular an electronic tag and/or a radiofrequency identification circuit (119i) is irremovably, or irremovably in use, associated with the capsule (100) for beverages.

According to another non-limiting aspect, the at least an identification device, in particular an electronic tag and/or a radiofrequency identification circuit (119i) is positioned in substantial correspondence of said lateral wall (101), optionally in substantial correspondence of an outer face of said lateral wall (101), and/or is positioned in substantial correspondence of the bottom portion (103), optionally introduced within the bottom portion (103).

According to another non-limiting aspect, the at least an identification device, in particular an electronic tag and/or a radiofrequency identification circuit (119i) is positioned in substantial correspondence of the perimeter ring (103r).

According to another non-limiting aspect, the at least an identification device, in particular an electronic tag and/or a radiofrequency identification circuit (119i) contains stored therein electronic data relating to the composition of said substance and/or contains stored therein an identification code of said capsule (100) for beverages.

According to another non-limiting aspect, said identification code (100z) is a univocal identification code.

### Method for Filling a Capsule

According to the present disclosure is furthermore described a method for filling a capsule, in particular a capsule for beverages, more in particular a capsule for beverages according to one or more of the aspects described therein, said method comprising:
the introduction (1001) of a cooled material (2100), optionally dry ice or solid carbon dioxide, destined to cause a gas formation, optionally carbon-dioxide gas, by state transformation, and/or the introduction of a gas, optionally carbon-dioxide gas, said gas optionally deriving from the state transformation of a cooled material (2100), optionally deriving from dry ice or solid carbon dioxide, into an opening (102c) of the capsule (100) opening itself on an inner cavity (100c) of the capsule (100),
the introduction (1002) of an at least partially powdery substance (2300) into an opening (102c) of the inner cavity (100c) of the capsule (100), optionally wherein the at least partially powdery substance (2300) comprises a mineralization mix, configured to cause a water mineralization, in particular a water mineralization for human consumption, within the opening (102c) of the capsule (100) opening on the inner cavity (100c) of the capsule (100),
a closing of the capsule (1004) comprising the closing of the opening (102c) of the capsule (100) such as the inner cavity (100c) is insulated from the outer environment,
wherein
the closing of the capsule (1004) is destined to allow an increase and/or a maintenance of the pressure within the inner cavity (100c) deriving from the state transformation of said cooled material (2100) and/or is destined to allow the maintenance of a predetermined inner pressure after the introduction of said gas.

According to another non-limiting aspect, the closing of the capsule (1004) takes place through a folding and/or crimping and/or welding and/or gluing process of at least a portion of the capsule (100), in particular of a head portion (102) of the capsule (100), said head portion (102) being the portion wherein said opening (102c) is originally present.

According to another non-limiting aspect, the introduction (1001) of said cooled material (2100) and/or of said gas is such as to determine, after the closing of the capsule (1004), a pressure lower than 0,5 bar and/or a pressure lower than the limits given by the European rule “Pressure Equipment Device” 2014/68/UE.

According to another non-limiting aspect, the method comprises the introduction (1003) of a predetermined quantity of a solvent, in particular of a predetermined quantity of water (2200), in particular of a predetermined quantity of distilled water (K), within the opening (102c) of the capsule (100) opening itself on the inner cavity (100c) of the capsule (100).

According to another non-limiting aspect, the introduction (1001) of said cooled material (2100) and/or of said gas and the introduction (1002) of said powdery substance (2300) take place before the closing of the capsule (1004).

According to another non-limiting aspect, the introduction (1003) of the predetermined quantity of solvent, in particular of the predetermined quantity of water (2200), in particular of the predetermined quantity of distilled water (K), takes place before the closing of the capsule (1004).

According to another non-limiting aspect, said predetermined quantity of solvent, in particular the predetermined quantity of water (2200), in particular the predetermined quantity of distilled water (K), is sufficient to cause an at least partial dissolution, preferably substantially total, of said powdery substance (2300).

According to another non-limiting aspect, the method comprises a cooling of the predetermined quantity of solvent, in particular of the predetermined quantity of water (2200), in particular of the predetermined quantity of distilled water (K), before the introduction (1003) of the predetermined quantity of solvent, in particular of the predetermined quantity of water (2200), in particular of the predetermined quantity of distilled water (K), into the opening (102c) of the capsule (100).

According to another non-limiting aspect, said cooling is a cooling close to the solidification temperature of said solvent, in particular close to the solidification temperature of said water (2200), more in particular near the solidification temperature of the distilled water (K), and/or the introduction (1003) of the predetermined quantity of solvent, in particular of the predetermined quantity of water (2200), more in particular of the predetermined quantity of distilled water (K), takes place at temperature substantially close to the solidification temperature.

According to another non-limiting aspect, the method comprises placing the capsule (100) in a controlled atmosphere, in particular substantially free or substantially filtered of organic and/or inorganic contaminants and/or with limited oxygen content or substantially devoid of oxygen, so that said controlled atmosphere is present within said inner cavity (100c).

According to another non-limiting aspect, the introduction (1001) of said cooled material (2100) and/or of said gas and the introduction (1002) of said powdery substance (2300), and/or the introduction of said solvent, takes place in said controlled atmosphere.

According to another non-limiting aspect, said controlled atmosphere comprises nitrogen.

### Device for Filling Capsules

According to the present disclosure it is described a device for filling capsules configured to operate according to the method according to the aspects described above.

### Device of Opening of Capsules for Beverages

According to the present disclosure it is therein described a device (300) for opening capsules for beverages (100), the opening device comprising:
at least a perforator (202) configured to perforate at least one between a head portion (102), a bottom portion (103) or a lateral wall (101) of the capsule (100) for beverages, realizing an opening (102c) such as to put an inner cavity (100c) of said capsule (100) for beverages, within which is contained a substance (S) under pressure, in substantial communication with an outer environment,
at least a striker (201) configured to retain the capsule (100) for beverages in a predetermined position,
wherein
the device for opening capsules is configured to vary a relative position between the capsule (100) for beverages and the perforator (202) at least between a first position wherein the perforator (202) is positioned at a distance from the capsule (100) for beverages and a second position wherein the perforator (202) is positioned at least partially into said capsule (100) for beverages, protruding inside the inner cavity (100c),
said device (300) for opening capsules for beverages (100) comprising a conveyor (202c) positioned in substantial correspondence of the perforator (202) to realize a seal in substantial correspondence of said opening (102c) and configured to convey at least part of the substance (S) along a predetermined direction or path of injection of the substance (S) in a container for a beverage, such as to discharge the pressure present in the inner cavity (100c) of the capsule (100) for beverages toward said predetermined direction or path of injection.

According to another non-limiting aspect, the striker (201) is substantially opposed to said perforator (202).

According to another non-limiting aspect, the striker (201) is positioned in substantial correspondence of said perforator (202).

According to another non-limiting aspect, the striker (201) extends, at least partially, along a substantially inclined plane, in particular substantially orthogonal, with respect to a line joining the first position relatively assumed between the capsule (100) for beverages and the perforator (202) and the second position relatively assumed between the capsule (100) for beverages and the perforator (202).

According to another non-limiting aspect, the perforator (202) is movable between a first position wherein the perforator (202) is positioned at a distance from the capsule (100) for beverages and a second position wherein the perforator is positioned at least partially within said capsule (100) for beverages, protruding inside of the inner cavity (100c) or, alternatively, the striker (201) is movable between a first position such as to put the perforator (202) at a distance from the capsule (100) for beverages and a second position such as to put the perforator at least partially within said capsule (100) for beverages, protruding itself inside the inner cavity (100c).

According to another non-limiting aspect, the perforator (202) is movable axially between said first position and said second position.

According to another non-limiting aspect, the striker (201) is movable between said first position and said second position.

According to another non-limiting aspect, the device (300) for opening capsules for beverages (100) is configured to vary a relative position between the capsule (100) for beverages and the perforator (202) by means of a substantially axial translation between the capsule (100) for beverages and the perforator (202) along a translation axis (A) or is configured to vary a relative position between the capsule (100) for beverages and the perforator (202) by means of a composite roto-translation movement, said composite roto-translation movement comprising:
a substantially axial translation between the capsule (100) for beverages and the perforator (202) along a translation axis (A);
a rotation relative between the capsule (100) for beverages and the perforator (202) around an axis, in particular an axis substantially coincident with the translation axis (A).

According to another non-limiting aspect, said striker (201) is configured to guide said capsule (100) for beverages in rotation, in particular being configured to guide the capsule (100) for beverages in rotation around said translation axis (A).

According to another non-limiting aspect, the device (300) comprises at least a first pusher (203) configured to push the capsule (100) for beverages against said striker (201).

According to another non-limiting aspect, said striker (201) is configured to engage the capsule (100) for beverages in substantial correspondence of the bottom portion (103).

According to another non-limiting aspect, the perforator (202) is configured to engage the capsule (100) for beverages in substantial correspondence of the head portion (102).

According to another non-limiting aspect, said pusher (203) is configured to push the bottom portion (103) of the capsule (100) for beverages against said striker (201).

According to another non-limiting aspect, the pusher (203) is movable relatively to said capsule (100) for beverages at least between a first position of substantial disengagement with respect to the capsule (100) for beverages and a second position of substantial engagement with the capsule (100) for beverages.

According to another non-limiting aspect, the pusher (203) rotates around a substantially inclined axis, in particular substantially orthogonal with respect to the translation axis (A), between at least a first position of substantial disengagement with respect to the capsule (100) for beverages and a second position of substantial engagement with the capsule (100) for beverages.

According to another non-limiting aspect, the pusher (203) is configured to engage in substantial correspondence of a perimeter ring (103r) of the bottom portion (103), optionally wherein the perimeter ring (103r) substantially develops on a plane and/or detects a transversal section larger with respect to a transversal section detected by the lateral wall (101) and/or protrudes outwardly with respect to said lateral wall (101).

According to another non-limiting aspect, the pusher (203) is configured to engage in substantial correspondence of a front wall (103f) of said perimeter ring (103r).

According to another non-limiting aspect, in said second position said pusher (203) pushes the bottom portion (103) against said striker (201).

According to another non-limiting aspect, in said second position, said pusher (203) is in substantial contact with said bottom portion (103).

According to another non-limiting aspect, in said second position, said pusher (203) is in substantial contact with the front wall (103f) of said bottom portion (103).

According to another non-limiting aspect, in said second position, said pusher (203) is configured to prevent a relative rotation between the capsule (100) for beverages and said striker (201).

According to another non-limiting aspect, the device for opening capsules for beverages (100) comprises a second pusher (203).

According to another non-limiting aspect, said second pusher is substantially diametrically opposed with respect to said first pusher.

According to another non-limiting aspect, said at least a first pusher (203), optionally each one between said first pusher and said second pusher, comprises a wall at least partially counter-shaped with respect to said lateral wall (101).

According to another non-limiting aspect, in at least said second position, said wall is positioned in substantial proximity to the lateral wall (101) of the capsule (100) for beverages.

### Method for Recording

According to the present disclosure it is also described a method for recording capsules, in particular of capsule for beverages (100) according to one or more of the aspects therein described, comprising:
a step of writing (4001) of electronic data in an identification device, in particular an electronic tag and/or a radiofrequency identification circuit (119i), said electronic data containing an identification code (100z) for a specific capsule (100) for beverages, optionally configured to identify the capsule (100) for beverages and/or a substance contained in the capsule (100) for beverages and/or a production and/or filling date of the capsule (100) for beverages;
a step of physical association (4002) between the identification device, in particular an electronic tag and/or a radiofrequency identification circuit (119i) and the capsule (100) for beverages,
a step of electronic reading (4003) of the identification device, in particular an electronic tag and/or a radiofrequency identification circuit (119i) associated to the capsule (100) for beverages, said step of reading (4003) being carried out by a device for supplying of the substance contained in the capsule (100) for beverages,
said method comprising at least a temporary storage (4005) of at least part of electronic data of the identification device, in particular an electronic tag and/or a radiofrequency identification circuit (119i) associated to the capsule (100) for beverages after the step of reading (4003),
said method comprising, after said at least a temporary storage (4005) of at least part of said electronic data, a step of transmission of at least part of the electronic data toward a remote device, and/or a step of alteration (4004) of the functioning parameters of the device for supplying of said substance, according to said at least part of said electronic data, and/or a step of electronic categorization (4006) of said capsule (100) for beverages as a capsule (100) for beverages used and/or emptied.

### Machine for Supplying a Beverage

According to the present disclosure it is also described a machine for supplying a beverage, comprising:
a device (300) for opening capsules for beverages (100) according to one or more of the aspects therein described,
a mixing device (504) configured to mix a substance (S) extracted from the capsule (100) for beverages such that, in use, can be produced a beverage comprising a fluid added with said substance (S),
a dispenser (501) configured to supply the beverage into a container (502) for beverages.

According to another non-limiting aspect, the machine for supplying a beverage comprises a water distillation device (1), comprising:
a body having a lateral wall and defining a cavity (2c, 2d) suitable for allowing the distillation of an amount of water to distill, wherein in said cavity are defined a distillation chamber and a condensation chamber, wherein the condensation chamber comprises a collection portion destined to collect at least temporarily distilled water (K),
at least a heater, configured to heat the amount of water (H) to distill present, in use, inside the condensation chamber (2c),
a cooler, configured to determine a condensation of a distillation steam,
wherein the condensation chamber (2c) comprises an outlet (2f), or through hole, configured to allow an outflow of the distilled water (K) from the collection portion (109).

According to another non-limiting aspect, the water distillation device (1) is a vacuum distillation device configured to carry out the distillation of the water at a pressure lower with respect to the atmospheric pressure.

According to another non-limiting aspect, the machine for supplying a beverage comprises a identification devices reader, configured to read an identification device of the capsule (100) for beverages, in particular to read an electronic tag and/or a radiofrequency identification circuit (119i) of the capsule (100) for beverages, said identification devices reader being configured to, and specifically destined to, electronically extract electronic data from the identification device, in particular from the electronic tag and/or from the radiofrequency identification circuit (119i).

According to another non-limiting aspect, the identification devices reader comprises a radiofrequency module specifically configured to allow the irradiating of at least a query signal for an identification device of a capsule (100) for beverages, and to receive a reply signal from said identification device of the capsule (100).

According to another non-limiting aspect, the machine for supplying a beverage comprises an identification devices reader, configured to read an identification device of the capsule (100) for beverages, in particular to read an electronic tag and/or a radiofrequency identification circuit (119i) of the capsule (100) for beverages, said identification devices reader being configured to, and specifically destined to, electronically extract at least an identification code (100z) for a specific capsule (100) for beverages from the identification device, in particular from the electronic tag and/or from the radiofrequency identification circuit (119i) and/or being configured to, and specifically destined to, identify the capsule (100) for beverages and/or the substance contained in the capsule (100) for beverages and/or a production and/or filling date of the capsule (100) for beverages through said identification device.

According to another non-limiting aspect, the machine for supplying a beverage is configured to supply said beverage only when the identification devices reader has carried out the reading of the identification device of the capsule (100) for beverages, in particular only when the identification devices reader has carried out the reading of the electronic tag and/or of the radiofrequency identification circuit (119i) of the capsule (100) for beverages and/or when the identification devices reader has extracted the identification code (100z) for a specific capsule (100) for beverages from the identification device and/or has identified the capsule (100) for beverages and/or the substance (S) contained in the capsule (100) for beverages and/or the production and/or filling date of the capsule (100) for beverages through said identification device.

According to another non-limiting aspect, the identification codes reader is configured to carry out an at least temporary storage (4005) of at least part of the electronic data extracted from the identification device, in particular from the electronic tag and/or from the radiofrequency identification circuit (119i) and/or to carry out an at least temporary storage (4005) of the identification code (100z) for a specific capsule (100) for beverages and/or to carry out an at least temporary storage of electronic data indicating the identification of the capsule (100) for beverages and/or of the substance (S) contained in the capsule (100) for beverages and/or of the production and/or filling date of the capsule (100) for beverages.

According to another non-limiting aspect, the machine for supplying a beverage is configured to carry out a transmission of at least part of the electronic data extracted from the identification device, in particular from the electronic tag and/or from the radiofrequency identification circuit (119i) toward a remote device.

According to another non-limiting aspect, the machine for supplying a beverage is configured to alter (4004) at least a functioning parameter according to said at least part of electronic data extracted from the identification device, and/or according to the identification code (100z) and/or according to the electronic data indicating the identification of the capsule (100) for beverages and/or of the substance (S) contained in the capsule (100) for beverages and/or of the production and/or filling date of the capsule (100) for beverages.

According to another non-limiting aspect, the machine for supplying a beverage is configured to electronically categorize (4006) said capsule (100) for beverages as capsule (100) for beverages used and/or emptied after the at least temporary storage (4005) and/or after the distribution of the beverage.

According to another non-limiting aspect, the functioning parameter comprises at least one among a supply speed of the substance (S) contained in the capsule (100) for beverages, a supply pressure of the substance (S) contained in the capsule (100) for beverages, a quantity of water, optionally of distilled water (K), to be distributed in the container (502), a temperature of the water to be distributed in the container (502), an introduction of additional gases in the container (502), an introduction of flavours in the container (502).

According to the present disclosure it is also described a machine for supplying a beverage, comprising a water distillation device (1) in turn comprising:
a body having a lateral wall and defining a cavity (2c, 2d) suitable for allowing the distillation of an amount of water to distill, wherein in said cavity are defined a distillation chamber and a condensation chamber, wherein the condensation chamber comprises a collection portion destined to collect at least temporarily distilled water (K),
at least a heater, configured to heat the amount of water (H) to distill present, in use, inside the condensation chamber (2c),
a cooler, configured to determine a condensation of a distillation steam,
wherein the condensation chamber (2c) comprises an outlet (2f), or through hole, configured to allow an outflow of the distilled water (K) from the collection portion (109),
wherein the water distillation device (1) is a vacuum distillation device configured to carry out the distillation of the water at a pressure lower with respect to the atmospheric pressure,
and wherein the machine for supplying a beverage comprises a device (300) for opening capsules for beverages (100) according to one or more of the aspects therein described, operatively coupled to the water distillation device (1) and/or comprises a mixing device (504) operatively coupled to the water distillation device (1), said mixing device (504) being configured to mix the substance extracted from the capsule (100) for beverages with said distilled water (K), the water distillation device (1) being configured to supply distilled water (K) to said device (300) for opening capsules for beverages (100) and/or to the mixing device (504) in such a way that, in use, a beverage can be produced.

According to another non-limiting aspect, the machine for supplying a beverage comprises a dispenser (501) operatively connected at least to the mixing device (504), said dispenser being configured to supply the beverage into a container (502) for beverages.

According to another non-limiting aspect, the device (300) for opening capsules for beverages (100) is configured to carry out the opening of a capsule (100) for beverages according to one or more of the aspects therein described.

According to another non-limiting aspect, the water distillation device (1) has an operating configuration of supply of distilled water (K), in which the distilled water (K) collected in the collection portion (109) is made flow into an outlet duct (10); said device (1) being configured to maintain within said a predetermined vacuum level with respect to a predetermined threshold in the continuation of said operating configuration of supply of distilled water (K).

According to another non-limiting aspect, the water distillation device (1) comprises an extraction pump, said extraction pump being configured to be activated during the operating configuration of supply to extract water from the collection portion (109) allowing to maintain the vacuum within the cavity and/or preventing the vacuum within the cavity from exceeding a predetermined threshold value, and/or preventing, during its operation, the access of air within said cavity.

According to another non-limiting aspect, said extraction pump is an occlusive pump and/or a volumetric pump and/or is a double-effect pump, and is configured to insulate the cavity from the outer environment during its operation and when stopped.

According to another non-limiting aspect, said extraction pump is an electro-actuated pump and/or is a magnetically driven pump.

According to another non-limiting aspect, the mixing device (504) is configured to distribute at least part of the substance (S) extracted from the capsule (100) for beverages within a container (502), in particular a bottle, for said beverage.

According to another non-limiting aspect, the mixing device (504) comprises at least a first duct (504c) within which, in use, flows at least part of the substance (S) extracted from the capsule (100) for beverages and at least a second duct (504a) into which, in use, flows distilled water (K) deriving from said water distillation device (1).

According to another non-limiting aspect, the mixing device (504) operatively connected to said device (300) for opening capsules, in particular with the conveyor (202c).

According to another non-limiting aspect, the first duct (504c) is operatively connected with the device (300) for opening capsules for beverages (100), and optionally is directly connected with the device (300) for opening capsules for beverages (100).

According to another non-limiting aspect, the second duct (504a) is operatively connected with the outlet of the water distillation device (1) from which, in use, the distilled water (K) outflows; said second duct (504a) being optionally directly connected to the outlet of the water distillation device (1) from which, in use, the distilled water (K) outflows.

According to another non-limiting aspect, the mixing device (504) comprises a third duct (504b), said third duct being configured to cause an extraction and/or to extract at least part of a volume of gas or air contained at least partially within the first duct (504c) and/or within the second duct (504a) and/or within the container (502), in particular the bottle, for said beverage.

According to another non-limiting aspect, the first duct (504c) and the second duct (504a) are at least partially coaxial and/or the first duct (504c) lies at least partially within the second duct (504a).

According to another non-limiting aspect, the third duct (504b) is at least partially coaxial with the first duct (504c) and/or the second duct (504a) and/or lies at least partially within the first duct (504c) and/or the second duct (504a).

According to another non-limiting aspect, the mixing device (504) is configured to distribute a predefined quantity of distilled water (K) within said first duct (504c) together with said at least part of the substance (S).

According to another non-limiting aspect, the first duct (504c) and/or the second duct (504a) and/or the third duct (504b) each comprise a respective ending portion.

According to another non-limiting aspect, the respective ending portion of the first duct (504c) and/or of the second duct (504a) and/or of the third duct (504b) realizes said dispenser (501).

According to another non-limiting aspect, the ending portion of the first duct (504c) is positioned at a different height with respect to the height at which the ending portion of the second duct (504a) is positioned, in particular at a height higher with respect to the height at which the ending portion of the second duct (504a) is positioned.

### Process of Supply of a Beverage

According to the present disclosure it is described a process of supply of a beverage, said process comprising a step of opening of the capsule (100) and at least a mixing of the substance (S) extracted from the capsule (100) with a predetermined amount of water, in order to realize said beverage.

According to the present disclosure it is also described a process of supply of a beverage, comprising a step of opening of the capsule (100) filled with the method according to one or more of the aspects therein described, and at least a mixing of the substance extracted from the capsule (100) with a predetermined amount of water, in order to realize said beverage.

In particular, according to the present disclosure is described a process of supply of a beverage which comprises:
a step of introduction of a capsule (100) for beverages into a machine for supplying a beverage, optionally a machine for supplying a beverage according to one or more of the aspects therein described,
a step of opening of a capsule (100) for beverages by means of a device (300) for the opening of capsules (100) for beverages according to one or more of the aspects therein described,
a step of mixing of the substance (S) extracted from the capsule (100) for beverages to produce a beverage comprising a fluid added with said substance (S),
a supply of the beverage within a container (502) for beverages by means of a dispenser (501) of the machine.

According to another non-limiting aspect, the process comprises a step of water distillation designed to produce said beverage, the step of distillation taking place by means of a water distillation device (1) which comprises:
a body having a lateral wall and defining a cavity (2c, 2d) suitable for allowing the distillation of an amount of water to distill, wherein in said cavity are defined a distillation chamber and a condensation chamber, wherein the condensation chamber comprises a collection portion destined to collect at least temporarily distilled water (K),
at least a heater, configured to heat the amount of water (H) to distill present, in use, inside the condensation chamber (2c),
a cooler, configured to determine a condensation of a distillation steam,
wherein the condensation chamber (2c) comprises an outlet (2f), or through hole, configured to allow an outflow of the distilled water (K) from the collection portion (109).

According to another non-limiting aspect, the step of distillation is a vacuum distillation step wherein the distillation of the water takes place at a pressure lower with respect to the atmospheric pressure.

According to another non-limiting aspect, the process comprises a step of electronic reading (4003) of an identification device, in particular an electronic tag and/or a radiofrequency identification circuit (119i) of the capsule (100) for beverages, said step of reading (4003) being carried out by a device for supplying the substance contained in the capsule (100) for beverages, said step of reading (4003) being designed to allow to extract, from the identification device, in particular an electronic tag and/or a radiofrequency identification circuit (119i), electronic data and in particular to extract an identification code (100z) for a specific capsule (100) for beverages optionally configured to identify the capsule (100) for beverages and/or a substance contained in the capsule (100) for beverages and/or a production and/or filling date of the capsule (100) for beverages through said identification device.

According to another non-limiting aspect, the supply of the beverage within a container (502) takes place only after the identification of the capsule (100) for beverages and/or after the step of reading (4003) of the electronic tag and/or of the radiofrequency identification circuit (119i) of the capsule (100) for beverages, optionally after the extraction of the identification code (100z) for a specific capsule (100) for beverages dal identification device and/or after the identification of the capsule (100) for beverages and/or of the substance (S) contained in the capsule (100) and/or of the production and/or filling date of the capsule (100) for beverages through said identification device.

According to another non-limiting aspect, the step of reading (4003) takes place through a reader of identification devices of the beverage supply machine.

According to another non-limiting aspect, the process comprises at least a temporary storage (4005) of at least part of the electronic data extracted from the identification device, in particular an electronic tag and/or a radiofrequency identification circuit (119i).

According to another non-limiting aspect, the process comprises, after said at least a temporary storage (4005) of at least part of said electronic data, a step of transmission of at least part of the electronic data toward a remote device, and/or a step of alteration (4004) of the functioning parameters of a machine for supplying a beverage, according to said at least part of said electronic data.

According to another non-limiting aspect, the process comprises, after said at least a temporary storage (4005) and/or after the supply of the beverage, a step of electronic categorization (4006) of said capsule (100) for beverages as capsule (100) for beverages used and/or emptied.

According to another non-limiting aspect, the device for supplying the substance contained in the capsule for beverages is a machine configured at least to mineralize water for drinking, and optionally is a machine configured to distill water, preferably but not limited thereto by means of vacuum distillation, and subsequently mineralize water for drinking.

According to another non-limiting aspect, the step of supply comprises, or causes, the production of mineralized water according to the composition of the substance extracted from the capsule (100) for beverages.

According to another non-limiting aspect, the step of physical association (4002) is a step wherein the identification device, in particular an electronic tag and/or a radiofrequency identification circuit (119i) is irremovably, or irremovably in use, associated to the capsule (100) for beverages.

According to another non-limiting aspect, the step of physical association (4002) comprises positioning the identification device, in particular an electronic tag and/or a radiofrequency identification circuit (119i) in substantial correspondence of said lateral wall (101), optionally in substantial correspondence of an outer face of said lateral wall (101), and/or comprises positioning the identification device, in particular an electronic tag and/or a radiofrequency identification circuit (119i) in substantial correspondence of the bottom portion (103) of the capsule (100) for beverages, optionally by means of the introduction within the bottom portion (103).

According to another non-limiting aspect, the step of physical association (4002) comprises positioning the identification device, in particular an electronic tag and/or a radiofrequency identification circuit (119i) in substantial correspondence of the perimeter ring (103r) of the bottom portion (103) of the capsule (100) for beverages.

According to another non-limiting aspect, the step of alteration (4004) of the functioning parameters of the device for supplying said substance comprises at least one among an adjustment of an amount of water to distribute into a container together with said substance when extracted from the capsule (100) for beverages, and/or an activation or deactivation of a gasifier for said water to supply together with said substance, and/or an activation or deactivation of a mixer configured to mix the water to supply in the container (502) with a further fluid, and/or an activation or deactivation of a heater or cooler for said water to distribute in said container, and/or comprises an adjustment of a supply pressure of said water to supply in said container.

According to another non-limiting aspect, the method comprises a step of storage (4007) of a copy (100′z) of said identification code (100z) on an electronic database (5000), said step of storage of said copy (100′z) of said identification code (100z) taking place in substantial correspondence of said step of writing (4001).

According to another non-limiting aspect, the step of electronic categorization (4006) of said capsule (100) for beverages as a capsule (100) for beverages used and/or emptied comprises at least a logical and/or electronic association between at least part of the electronic data read object of the at least temporary storage (4005), with a flag or data indicating the use of the capsule (100) for beverages and/or comprises the cancellation of a copy (100′z) of said identification code (100z) from said electronic database (5000).

According to another non-limiting aspect, said identification code is a univocal identification code suitable for allowing the univocal identification of a specific capsule (100) for beverages.

According to another non-limiting aspect, the step of water distillation (1) is a step wherein the distilled water (K) is collected in a collection portion (109) of the water distillation device (1) and made flow into an outlet duct (10) of the water distillation device (1), and the vacuum is maintained during the supply of distilled water (K) from the outlet duct (10).

According to another non-limiting aspect, the step of water distillation comprises a step of activation of an extraction pump to carry out an extraction of the distilled water (K) from the collection portion (109) allowing to maintain the vacuum within the cavity and/or preventing the vacuum within the cavity from exceeding a predetermined threshold value, and/or preventing, during the functioning of the extraction pump, the access of air within said cavity.

According to another non-limiting aspect, the step of mixing is carried out by means of a mixing device (504).

According to another non-limiting aspect, the process comprises an operating connection of the mixing device (504) with the device (300) for opening capsules, in particular with a conveyor (202c) of the device (300) for opening capsules positioned in substantial correspondence of a perforator (202) of the capsule (100) for beverages in order to realize a seal in substantial correspondence of an opening (102c) of the capsule (100) for beverages made by the perforator (202).

According to another non-limiting aspect, the process comprises a step of pressure release present in the inner cavity (100c) of the capsule (100) by effect of the opening made by the perforator (202).

According to another non-limiting aspect, the process comprises a step of supply of a first duct (504c) of the mixing device (504) with at least part of the substance (S) extracted from the capsule (100) for beverages and comprises a step of supply of a second duct (504a) of the mixing device (504) with distilled water (K), optionally deriving from the water distillation device (1).

According to another non-limiting aspect, the process comprises a step of extraction of at least part of a volume of gas or air contained at least partially into the first duct (504c) and/or into the second duct (504a) and/or into the container (502), in particular the bottle, for said beverage by means of a third duct (504b) of the mixing device (504).

### FIGURES

The object of the present disclosure will be now described with particular reference to some preferred and non-limiting embodiments and with the aid of the attached figured. A brief description of these figures is provided below.

FIG. 1 shows a capsule, in particular a capsule for beverages, introduced into a housing of a device for opening capsules.

FIG. 2 shows the capsule with a device for the opening according to a first embodiment.

FIG. 3 shows the capsule with a device for the opening according to a second embodiment.

FIG. 4 shows the capsule with a device for the opening according to a third embodiment.

FIG. 5 shows a detail of a first engagement configuration of the capsule through the device according to the third embodiment.

FIG. 6 shows a detail of a second engagement configuration of the capsule through the device according to the third embodiment.

FIG. 7 shows a detail of a substance introduced into an inner cavity of the capsule.

FIG. 8 shows a block diagram of a process for the filling of the capsule.

FIG. 9, FIG. 10 and FIG. 11 show a first, a second and a third position for an identification device, in particular an electronic tag and/or a radiofrequency identification circuit associated to the capsule for beverages.

FIG. 12 shows a block diagram related to operations carried out in relation with said identification device, in particular an electronic tag and/or a radiofrequency identification circuit.

FIG. 13 shows a schematic diagram of the association between an identification code and a capsule for beverages.

FIG. 14 shows a schematic representation of a preferred embodiment of a water distillation device operatively coupled to the device for opening capsules described therein.

FIG. 15 shows a schematic representation of a specific embodiment of a mixing duct, according to the present disclosure.

### DETAILED DESCRIPTION

The present disclosure is in particular intended to provide a detail of a device for opening capsules for beverages, a method for opening capsules for beverages and a machine (and process) for supplying a beverage.

Before entering into the details of the specific structural configuration of the device and the machine, and before providing the details of the steps that are part of the above-mentioned method and process, the Applicant considers useful to provide an overview of a particular embodiment of a capsule for beverages which is intended to be opened by the above-mentioned device.

With reference to FIG. 1, with the reference number 100 is indicated as a whole a capsule, in particular a capsule for beverages. The capsule of FIG. 1 is shown in an its non-limiting shape provided with a tapered portion, but more generally comprises a lateral wall 101, a head portion 102, and a bottom portion 103.

The lateral wall 101, the head portion 102 and the bottom portion 103, define an inner cavity 100c in use insulated from the outer environment and configured, to contain, in use, a substance S at least partially fluid and/or powdery destined to produce a beverage, in the form of an additivated liquid of which the substance represents a determined part by weight, in particular but not limited thereto a minimum part by weight. As it will be better clarified in the following portion of the description, in fact, the substance can preferably constitute a mineralization mix for water, capable of allowing to the user to realize a water with a mix of minerals selected from substantially distilled and/or minimally mineralized and/or substantially pure water.

In particular, the capsule for beverages 100 therein described is configured to withstand within the inner cavity 100c a predetermined pressure produced by the substance. Although this should not be intended in a limiting manner, the pressure is a pressure lower than 0.5 bar and/or is a pressure lower than the limits given by the European rule “Pressure Equipment Device” 2014/68/UE. This allows to transport the capsule described therein without particular safety precautions.

The capsule presents a particular construction so that at least one among the head portion 102 and/or the bottom portion 103 and/or the lateral wall 101 is configured to be perforated, in a predetermined opening portion, by a perforator 202 of a device for opening capsules 300 determining an opening of the inner cavity 100c destined to cause an outflow of the substance; in particular the outflow is at least partially, in particular substantially integrally, produced by the pressure within the inner cavity 100c. The device for opening capsules 300 can be provided with a door schematically shown in FIG. 1 with the reference number 301.

In a preferred but non-limiting, the lateral wall 101, the head portion 102 and the bottom portion 103 are realized in metallic material, optionally integrally in metallic material. However, this should not be intended in a limiting manner, as the Applicant has conceived further embodiments of the capsule therein described wherein even only one among said lateral wall 101, head portion 102 or bottom portion 103 is realized in metallic material. In a non-limiting embodiment, this metallic material is aluminum or its alloy and/or steel, for example stainless steel. In particular, this allows to have a light yet robust capsule, capable of maintaining a predetermined shape even when subjected to a significant inner pressure. The use of aluminum and/or steel, for example stainless steel, is compatible with food applications. The capsule described therein is therefore reusable, at least once and preferably a plurality of times. In order to ensure a sufficient strength, the capsule for beverages 100 described therein is realized in such a way as to withstand inner pressures at least equal to 100 bar, more preferably at least equal to 150 bar, even more preferably at least equal to 200 bar.

Since the capsule 100 for beverages therein described is realized at least partially in metallic material, the aforementioned perforator 202 shall be conveniently realized in a material sufficiently rigid and/or strong to allow a perforation of a large quantity of capsules for beverages 100 without being damaged by said perforation. In a non-limiting embodiment, the perforator 202 is realized in a composite material and/or metallic material, optionally tungsten carbide or case-hardened steel.

The head portion 102 and the bottom portion 103 are joined to the lateral wall 101. It is observed in particular that the lateral wall 101 comprises a first portion, in particular a first ending portion, and comprises a second portion, in particular a second ending portion; the first portion of the lateral wall 101 is directly joined, in particular uninterruptedly, to the head portion 102; the second portion of the lateral wall 101 is directly joined, in particular uninterruptedly, to the bottom portion 103.

Although various solutions for the reciprocal joining among the head portion 102, the bottom portion 103 and the lateral wall 101 can be conceived—for example, by welding or folding—the embodiment of the capsule shown in the attached figures is such that the lateral wall 101, the head portion 102 and the bottom portion 103 are realized in a single piece, or are integral, being in particular obtained from a single sheet of metallic material, optionally by folding and/or deformation.

In a non-limiting and alternative embodiment, not shown in the attached figures, the lateral wall 101 is joined by means of a welding and/or folding and/or crimping and/or gluing process to the head portion 102 and/or to the bottom portion 103.

The capsule described therein comprises an opening 102c configured to be in use closed determining an insulation of the inner cavity 100c from the outer environment. This insulation is sufficient to determine—for an indefinitely long time—a maintenance of a predetermined pressure.

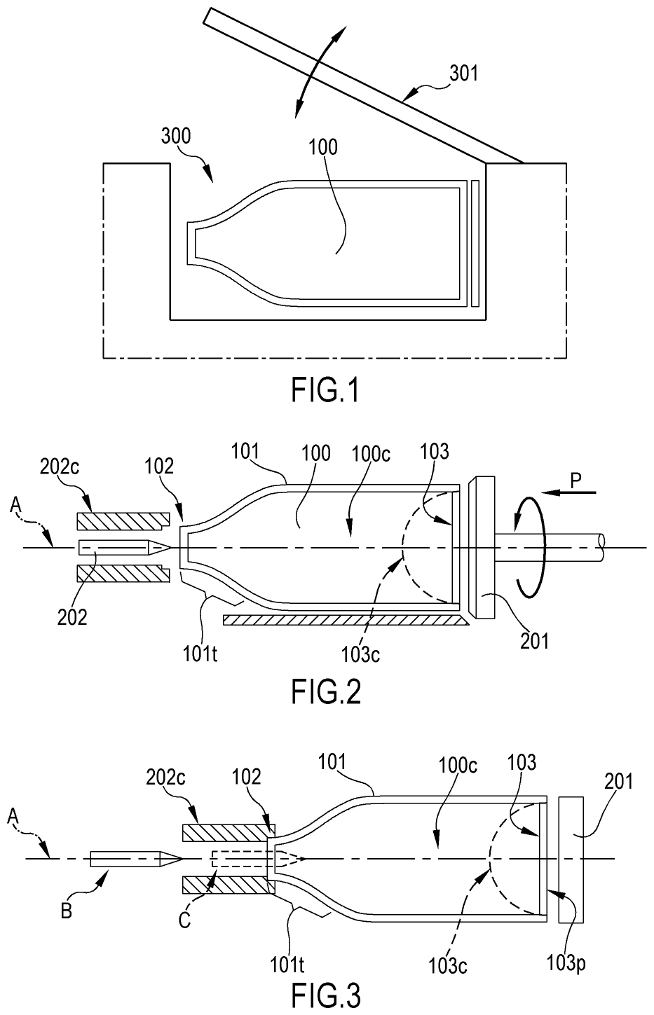

With specific reference to the embodiments of the capsule shown in FIGS. 2, 3 and 4, it is observed that the head portion 102 defines an opening 102c configured to allow an introduction of said substance within said inner cavity 100c and is closed again by means of at least a welding and/or folding and/or crimping and/or gluing operation destined to seal the opening 102c to allow an insulation of the inner cavity 100c from the outer environment. The opening 102c corresponds substantially to the previously mentioned opening position. In other words, this means that an opening process of the capsules described therein specifically comprises a perforation by means of the perforator 202 of the capsule in a position substantially corresponding to what was originally the one of the opening 102c.

This means that at least one embodiment of the body of the capsule 100 for beverages described therein is characterized by having, at least partially, a deformability property such that it can cause a closure of the opening 102c at the end of the filling of the inner cavity 100c. This deformability property determines the possibility of deforming the body of the capsule 100 where necessary to close the opening 102c without causing weakenings and/or fractures, even if only partial, in remaining portions of the body of the capsule 100 for beverages not affected by the deformation.

Preferably, but not limited thereto, the lateral wall 101 comprises a tapered portion 101t. This tapered portion causes the capsule described therein to assume a vaguely bottle-like shape and can be configured to favor the alignment of the capsule in a housing in substantial correspondence of which the perforator 202 lies. This can allow a greater precision of perforation. In particular, embodiments of the capsule described therein present a tapered portion 101t that lies in substantial correspondence of the head portion 102. The tapered portion 101t presents a transversal section gradually reducing towards the head portion 102.

In a preferred but non-limiting embodiment, the lateral wall 101 detects a substantially circular transversal section, and/or is substantially tubular in profile. This allows to the user not to have to select a particular spatial orientation for the capsule at least in relation to the main axis A along which the capsule develops as a solid of revolution.

In the embodiments shown in FIGS. 2 and 3, the bottom portion 103 presents a substantially planar wall, in particular developing on a plane orthogonal to the main axis A.

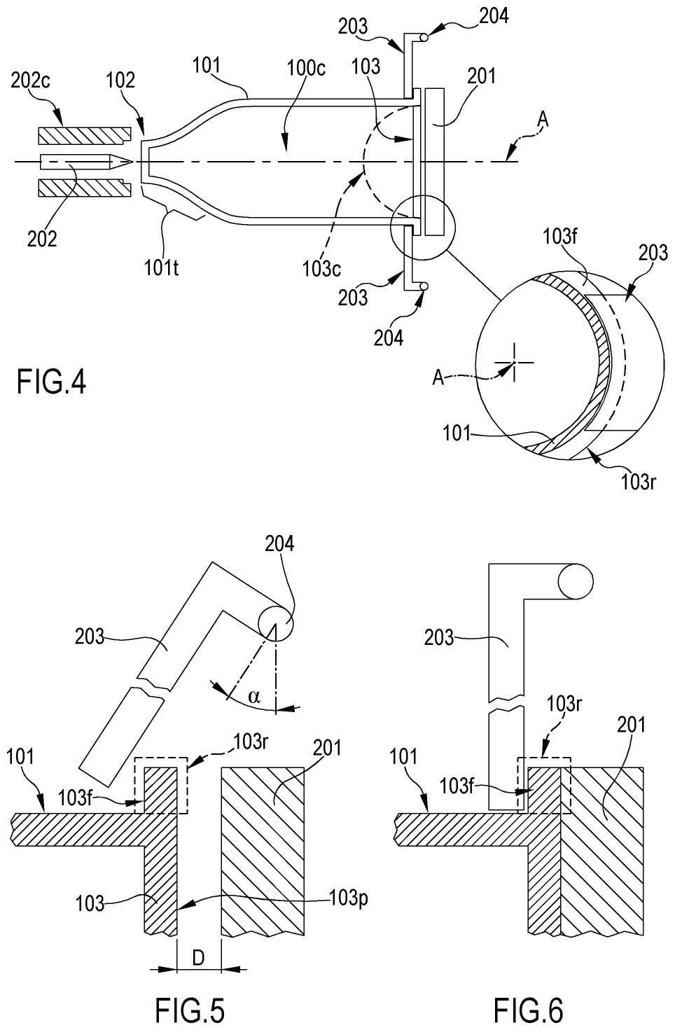

In the embodiments shown for example in FIGS. 4, 5, and 6, the capsule comprises at least a perimeter ring 103r of the bottom portion 103, which develops substantially on a plane, in particular on a plane aligned with the remaining, central portion of the bottom portion 103. This perimeter ring 103r detects a transversal section larger than a transversal section detected by the lateral wall 101 and/or protrudes outwards with respect to the lateral wall 101. The use of a substantially planar bottom portion 103 allows to favor the correct positioning of the capsule for example in a box, and as it will be possible to better observe from the following portion of description, also allows to offer a valid support when the capsule is to be opened by the perforator 202.

As already briefly mentioned before, the capsule comprises a longitudinal axis A passing through the inner cavity 100c. In particular, the longitudinal axis A is substantially orthogonal with respect to at least part of, preferably all of, the bottom portion 103 and/or is the axis around which said lateral wall 101 develops.

In a non-limiting embodiment, however, the bottom portion 103 cannot be substantially or integrally planar and, in particular, can show a concave portion 103c protruding within the inner cavity 100c. Where it is present the perimeter ring 103r previously described, the concave portion 103c lays into said perimeter ring. In FIGS. 2, 3 and 4, the concave portion 103c is represented by means of a dotted line, and presents a cusp aligned with the longitudinal axis A of the capsule.

The perimeter ring 103r previously described can have a specific function described hereinafter. In particular, the perimeter ring 103r is configured to be engaged by a pusher 203, in particular by a movable and/or rotating pusher 203. As it can be seen in the detail provided in FIGS. 5 and 6, the perimeter ring 103r comprises a rear wall 103p and a front wall 103f facing the lateral wall 101 and/or oblique with respect to the lateral wall 101; in the embodiments of FIGS. 5 and 6, the front wall 103f of the perimeter ring 103r faces the lateral wall 101 and is positioned along an extension direction substantially orthogonal with respect to the lateral wall 101. The front wall 103f is a substantially annular wall and/or detects a substantially annular profile protruding outwards with respect to the lateral wall 101.

The rear wall 103p delineates an ending wall for the capsule. The Applicant observes that the rear wall 103p is substantially oblique with respect to said lateral wall 101; more precisely, in the embodiments of FIGS. 5 and 6, the rear wall 103p is substantially orthogonal with respect to the lateral wall 101. Thus, in the embodiment of FIG. 5 and of FIG. 6, the rear wall 103p is substantially parallel to said front wall 103f, but presents an area substantially larger with respect to the latter.

On the opposite part of the capsule, the head portion 102 comprises a substantially planar section.

The Applicant has conceived a particular embodiment of the substance, which is described hereinafter.

La substance is configured to generate said pressure when contained in the inner cavity 100c. Preferably, the substance, which is a compound substance, is configured to generate said pressure by state transformation, in particular by changing state at least for part of its volume and/or weight, starting from a liquid and/or solid state to reach a substantially at least partially gaseous state destined to determine an increase of volume suitable for pressurizing the inner cavity 100c when opportunely closed.

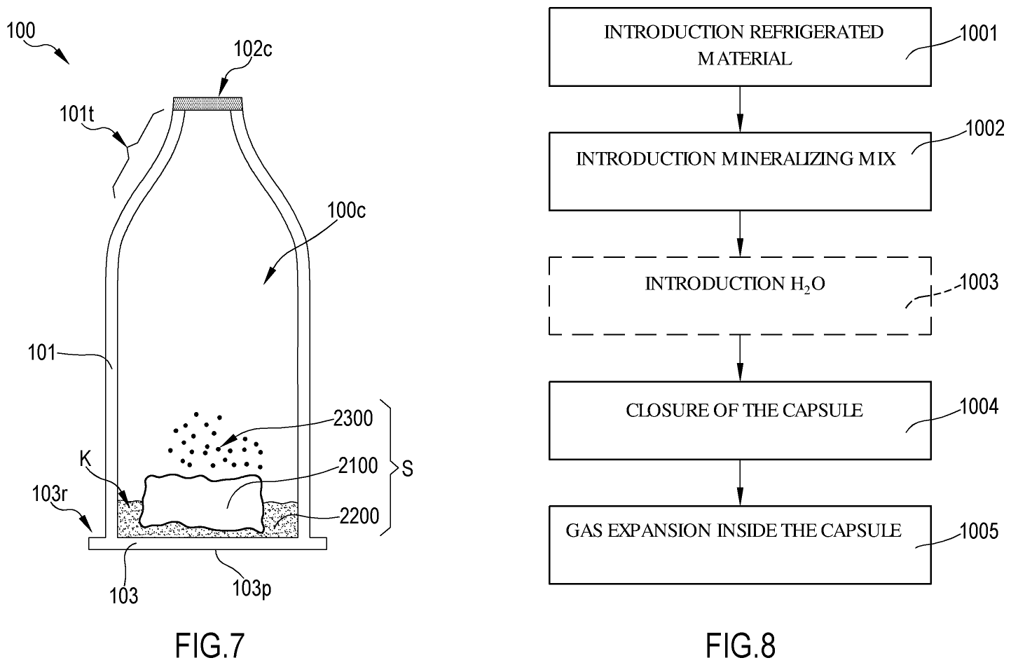

FIG. 7 shows schematically a preferred embodiment of the substance described therein.

The aforementioned substance comprises an at least partially powdery substance 2300, optionally a mineralization mix, configured to cause a water mineralization, in particular a water mineralization for human consumption. For this reason, the substance can comprise at least one among magnesium, potassium, calcium, fluorine, iron, sodium, sulphur, silicon minerals and in particular can comprise magnesium carbonate or bicarbonate and/or calcium carbonate or bicarbonate. Additionally or alternatively to the above, said substance can comprise a solvent, in particular water 2200, in particular distilled water.

In an embodiment, in particular preferred, the substance comprises a cooled and/or cooling and/or originally cooled material 2100, in particular dry ice or solid carbon dioxide, destined to cause a gas formation, in particular gaseous carbon dioxide, by state transformation, and/or comprises a gas, in particular gaseous carbon dioxide, and this gas in particular derives from a state transformation of a cooled and/or cooling and/or originally cooled material 2100, preferably deriving from a state transformation of dry ice or solid carbon dioxide.

The Applicant has observed that the composition of the substance described above is particularly suitable to allow a rapid dissolution of its mineral portion in a predetermined quantity of water, even distilled water, without the formation of precipitates or, anyway, solid particles. This allows using the capsule described therein with the substance described therein to realize a mineralization of distilled water which allows to the user to choose at will which mineral mix and therefore which flavor to give to the water he intends to drink. This allows to the user to start from a single source material-water, preferably distilled-and realize a plurality of different types of water by simply selecting one among a plurality of capsules for beverages 100 at his disposal, in particular the capsule containing the substance destined to generate the beverage the user wishes to drink in the future.

Therefore, the present disclosure shows a method for filling a capsule, in particular a capsule for beverages, which is described hereinafter with particular reference to the block diagram of FIG. 8 and with reference to the schematic representation of FIG. 7.

The method first of all comprises the introduction (block 1001, FIG. 8) of a cooled material 2100, which in the present detailed description is for example and not limited thereto dry ice or solid carbon dioxide, into an opening 102c of the capsule 100 opening on an inner cavity 100c of the capsule 100.

This cooled material 2100, in particular this dry ice or solid carbon dioxide is destined to cause a formation of gases, in particular, but not limited thereto, gaseous carbon dioxide, by state transformation.

Alternatively or in combination with the above, the method comprises the introduction (block 1001, FIG. 8) of a gas, optionally gaseous carbon dioxide, within an opening 102c of the capsule 100 opening on an inner cavity 100c of the capsule 100. Preferably, but not limited thereto, the gas derives from state transformation of a cooled material 2100, and optionally derives from dry ice or solid carbon dioxide.

The method further comprises (block 1002, FIG. 8), the introduction of an at least partially powdery substance 2300 within the opening 102c of the inner cavity 100c of the capsule 100. The introduction of the powdery substance 2300 within the capsule 100 can take place before the introduction of the cooled material 2100, or substantially at the same time with the cooled material 2100, or after the introduction of the cooled material 2100.

In a preferred but non-limiting embodiment, the at least partially powdery substance 2300 comprises a mineralization mix, configured to cause a water mineralization, in particular a mineralization of water for human consumption. This is particularly valid when the capsule 100 is destined to an application for beverages, i.e. it is destined to be used for the production of beverages.

When at least the powdery substance 2300 and the cooled material 2100 and/or gas have been introduced within the inner cavity of the capsule 100, the method described therein comprises the closing (block 1004, FIG. 8) of the capsule, in particular comprising the closing of the opening 102c of the capsule 100 in such a way that the inner cavity 100c is insulated from the outer environment. This allows to insulate the substance contained in the capsule 100 effectively, and allows a storage for significantly long times.

The closing of the capsule (block 1004, FIG. 8) is destined to allow an increase and/or a maintenance of pressure within the inner cavity 100c deriving from the state transformation of said cooled material 2100 and/or is destined to allow the maintenance of a predetermined inner pressure after the introduction of the gas.

Therefore the introduction (block 1001, FIG. 8) of the cooled material 2100 and/or of the gas and the introduction (block 1002, FIG. 8) of the powdery substance 2300 take place before the closing of the capsule (block 1004, FIG. 8).

The closing of the capsule (block 1004, FIG. 8) takes place through a folding and/or crimping and/or welding and/or gluing process of at least a portion of the capsule 100, and such folding and/or crimping and/or welding and/or gluing process takes place, in particular, in correspondence of the head portion 102 of the capsule 100, in particular since such head portion 102 is, in fact, the portion wherein is present the opening 102c.

Although the present disclosure is not limited to a unique and specific step of introduction (block 1001, FIG. 8) of cooled material 2100 and/or of gas, in a preferred but non-limiting embodiment this introduction is such as to determine, after the closing of the capsule (block 1004, FIG. 8), a pressure lower than 0.5 bar and/or a pressure lower than the limits given by the European rule “Pressure Equipment Device” 2014/68/UE. This allows to transport the capsule described therein without any particular safety precautions.

As it is possible to observe from FIG. 8, the method according to the present disclosure can comprise the introduction (block 1003, FIG. 8) of a predetermined quantity of a solvent, in particular of a predetermined quantity of water 2200, in particular of a predetermined quantity of distilled water, within the opening 102c of the capsule 100 which opens on the inner cavity 100c of the capsule 100. This step is optional, and for this reason also in FIG. 8 the relevant block 1003 is represented with a dotted line.

The introduction of the predetermined quantity of solvent (block 1003, FIG. 8), can take place substantially at the same time of the introduction of the cooled material 2100 and/or gas, and/or can take place substantially at the same time of the introduction of the powdery substance 2300, or—alternatively—can take place in substantial advance with respect to the introduction of the cooled material 2100 and/or gas, and/or of the powdery substance 2300 into the inner cavity 100c of the capsule 100. Still alternatively, the introduction of the predetermined quantity of solvent (block 1003, FIG. 8) can take place after the introduction of the cooled material 2100 and/or gas, and/or of the powdery substance 2300 into the inner cavity 100c of the capsule 100; in any case, the introduction of the predetermined quantity of solvent (block 1003, FIG. 8) takes place before the closing of the capsule (block 1004, FIG. 8).

The purpose of the predetermined quantity of solvent introduced into the capsule, in particular of the predetermined quantity of water 2200, in particular of the predetermined quantity of distilled water, is to allow an at least partial dissolution, preferably a substantially overall dissolution, of said powdery substance 2300. In this way, the substance eventually contained in the capsule 100 is substantially in the form of a fluid or gel, albeit of high viscosity. The Applicant in particular observes that the use of a substance in the form of a liquid or gel, in particular where the application of use of the capsule is directed to the realization of mineralized water by means of mineralization induced by the substance extracted from the capsule 100, facilitates the complete dissolution of the substance in the water without formation of solid residuals and/or precipitates and also allows an easier mixing process, since—in that case—the realization of the mineralized water takes place by means of a liquid/liquid or in any case fluid or gel/liquid mixing.

In a preferred but non-limiting embodiment the method described therein can comprise a cooling of the predetermined quantity of solvent, in particular of the predetermined quantity of water 2200, in particular of the predetermined quantity of distilled water, before the introduction (block 1003, FIG. 8) of the predetermined quantity of solvent, in particular of the predetermined quantity of water 2200, in particular of the predetermined quantity of distilled water, within the opening 102c of the capsule 100. This can be particularly useful where the cooled material introduced into the capsule 100 is at a significantly low temperature (as in the case, for example, of dry ice), since in this way any sudden heating of such cooled material is contained and any reactions due to such sudden heating are consequently limited. Furthermore, the use of a previously cooled solvent allows a better quality of preservation of the powdery substance, in particular if at least part of it has a biological origin and/or composition.

In a preferred but non-limiting embodiment, the cooling is a cooling close to the solidification temperature of the solvent, in particular close to the solidification temperature of the water 2200, more in particular close to the solidification temperature of the distilled water. This allows to limit the volume of the solvent and assists the expansion of volume and thus the increase of pressure within the inner cavity 100c of the capsule 100 only at a later time, when the solvent and the cooled material and/or gas will have expanded by natural heating towards room temperature. In other words, therefore, the introduction (block 1003, FIG. 8) of the predetermined quantity of solvent, in particular of the predetermined quantity of water 2200, more in particular of the predetermined quantity of distilled water, takes place at a temperature substantially close to the solidification temperature.

The Applicant has observed that determined substances, in order to maintain the purity and/or prevent the oxidation and/or guarantee the sterility and/or in order to increase the storage time for the capsule 100, must be treated in a particular manner; in some cases, it cannot be convenient to proceed with the filling of the capsule 100 in a traditional free atmosphere. Therefore, a particular embodiment of the method described therein comprises placing the capsule 100 in a controlled atmosphere, in particular substantially free or substantially filtered of organic and/or inorganic contaminants, and/or substantially deprived at least of oxygen, so that said controlled atmosphere is present within said inner cavity 100c.

It is observed in particular that the introduction (block 1001, FIG. 8) of the cooled material 2100 and/or of the gas and the introduction (block 1002, FIG. 8) of the powdery substance 2300, and/or the introduction of the solvent, take place in said controlled atmosphere.

Preferably, but not limited thereto, such controlled atmosphere comprises substantially nitrogen.

In the light of the foregoing, it therefore appears clear that it is possible to realize a process for the supply of a beverage comprising the previously described opening of the capsules 100, and a mixing of the substance S extracted from the capsule 100 with a predetermined amount of water, in order to realize said beverage, and/or comprising the opening of the capsule 100 filled according to the previously described method. The beverage supplied therefore is realized as a fluid additivated at least by the substance S extracted from the capsule 100 for beverages.

In particular this process can be carried out by means of a machine for supplying beverages such as the one schematically shown in FIG. 13. Such a machine preferably comprises a vane 503 within which the capsule 100 is in use introduced, a dispenser 501 for mineralized water, configured to supply said mineralized water, and more generally a beverage, out of the machine 500, in particular into a container 502, and comprises a mixer 504 destined to mix the substance extracted from the inner cavity 100c of the capsule with a predetermined amount of water. In particular, the machine for supplying beverages also comprises at least one perforator 202 suitable for allowing the opening of the inner cavity of the capsules.

As briefly mentioned in the introductory portion of the present detailed description, the present disclosure concerns a device for opening capsules for beverages that is preferably conceived to cooperate in the opening of the specific embodiment of the capsule described therein.

Such device 300 comprises at least one perforator 202 configured to perforate at least one among a head portion 102, a bottom portion 103 or a lateral wall 101 of the capsule 100 for beverages, creating an opening 102c such as to place an inner cavity 100c of said capsule 100 for beverages within which is contained a pressurized substance S in substantial communication with an outer environment. The device 300 further comprises at least one striker 201 configured to hold the capsule 100 for beverages in a predetermined position. The striker 201 is configured to cooperate with the perforator 202 for opening of the capsules 100 for beverages.

The device 300 comprises a conveyor 202c positioned in substantial correspondence of the perforator 202 to realize a seal in substantial correspondence of said opening 102c and configured to convey at least part of the substance S along a predetermined direction or injection path of the substance S into the container 502 for the beverage, so as to release the pressure present in the internal cavity 100c of the capsule 100 for beverages towards a predetermined direction or injection path.

Generally, the device for opening capsules is configured to vary a relative position between the capsule 100 for beverages and the perforator 202 at least between a first position in which the perforator 202 is positioned at a distance from the capsule 100 for beverages and a second position in which the perforator 202 is positioned at least partially within said capsule 100 for beverages, protruding within the inner cavity 100c. In other words, the capsule 100 for beverages can be held in a fixed position, and in this case it will be the perforator 202 that moves, or alternatively, the perforator can be held in a fixed position, and the perforation of the capsule 100 for beverages will take place by means of a movement of the capsule itself. Still alternatively, in use, in order to allow the perforation, both the capsule 100 for beverages and the perforator 202 are moved.

FIG. 3 shows in particular the first position relatively assumed between the perforator 202 and the capsule 100 for beverages. In detail, with arrow B is represented the configuration in which the perforator 202 is positioned at a distance from the capsule 100 for beverages; with arrow C, which identifies the shape of the dashed perforator, is represented the configuration in which the perforator is positioned at least partially into said capsule 100 for beverages.

In the embodiments schematically shown in FIGS. 2, 3, 4, the device 300 for opening capsules for beverages 100 according to the present disclosure is in particular constructed in such a way that the striker 201 is substantially opposed to said perforator 202. This is not to be intended in a limiting manner, since in an alternative embodiment (and not shown in the attached figures), the striker 201 is positioned in substantial correspondence of said perforator 202, and is in particular positioned in substantial correspondence of the bottom portion 103 of the capsule for beverages.

More precisely, the striker 201 extends, at least partially, along a substantially inclined plane, in particular substantially orthogonal, with respect to a conjunction of the first position relatively assumed between the capsule 100 for beverages and the perforator 202 and the second position relatively assumed between the capsule 100 for beverages and the perforator 202.

In an embodiment, the perforator 202 is movable between a first position wherein the perforator 202 is positioned at a distance from the capsule 100 for beverages and a second position wherein the perforator is positioned at least partially within said capsule 100 for beverages, protruding into the inner cavity 100c or, alternatively, the striker 201 is movable between a first position such that the perforator 202 is placed at a distance from the capsule 100 for beverages and a second position such that the perforator is placed at least partially into the capsule 100 for beverages, protruding within the inner cavity 100c.

As shown in FIG. 3, the striker 202 is movable axially between said first position (identified by reference B in FIG. 3) and said second position (identified by reference C in FIG. 3). Alternatively, the striker 201 is movable axially between said first position and said second position. The use of an axial movement allows realizing a simple device 300 and therefore allows to contain the production costs of the device itself and simplifies the design of the device itself.

In a particular embodiment, therefore, the device for opening capsules for beverages 100 is configured to vary a relative position between the capsule 100 for beverages and the perforator 202 by means of a substantially axial translation between the capsule 100 for beverages and the perforator 202 along a translation axis A, or is configured to vary a relative position between the capsules 100 for beverages and the perforator 202 by means of a composite rototranslation movement, said composite movement comprising:
a substantially axial translation between the capsule 100 for beverages and the perforator 202 along a translation axis A;
a rotation relative between the capsule 100 for beverages and the perforator 202 around an axis, in particular an axis substantially coincident with the translation axis A.

The Applicant observes that in the preceding portion of the description the letter “A” has been used to designate the longitudinal axis of the capsule; the translation axis described therein has been deliberately referred to with the same letter since, as represented in the attached figures, the translation axis actually coincides with the longitudinal axis of the capsule. Thanks to this aspect, the supply of forces during the perforation of the capsule is particularly uniformed.

In an embodiment, schematically represented in FIG. 2, the striker 201 is configured to guide the capsule 100 for beverages in rotation against the perforator 202. The striker 201, which as represented in FIG. 2 is positioned in use in substantial correspondence of the bottom portion of the capsule 100 for beverages, is in particular configured to guide the capsule 100 for beverages in rotation around said translation axis A. The striker 201 is therefore an actively moved striker.

As schematically shown in FIGS. 4, 5 and 6, in a preferred but non-limiting embodiment, the device for the opening of the capsule 100 for beverages comprises at least a first pusher 203 configured to push the capsule 100 for beverages against said striker 201. In detail in FIGS. 4, 5 and 6 a first pusher and a second pusher 203, in particular opposed, are shown cooperating to push the capsule for beverages against the striker 201. The first and second pusher lie in correspondence of two opposite sides of the capsule 100. It is observed that in such specific embodiment the perforator 202 is configured to engage the capsule 100 for beverages in substantial correspondence of the head portion 102.

In particular, the pusher 203 (and where present, the first and second pusher) is configured to push the bottom portion 103 of the capsule 100 for beverages against said striker 201.

Where the perforator is in correspondence of the striker 201, the pusher 203 is also configured to hold the capsule 100 for beverages against the striker 201 even when it is subjected to a perforation force induced by the perforator 202 that would otherwise cause it to move away from the striker 201 itself.

As it can be seen in FIGS. 4, 5 and 6, the pusher 203 is movable in relation to the capsule 100 for beverages at least between a first position of substantial disengagement with respect to the capsule 100 for beverages and a second position of substantial engagement with the capsule 100 for beverages.

In particular, the pusher 203 rotates around a substantially inclined axis, in particular substantially orthogonal, with respect to the translation axis A, between at least a first position of substantial disengagement with respect to the capsule 100 for beverages and a second position of substantial engagement with the capsule 100 for beverages. The rotation angle α (FIG. 5) can be sufficient to determine said disengagement. FIGS. 4 and 6 show respective configurations in which the pusher 203 in engaged on the capsule, in particular against the perimeter ring 103r.

The pusher 203 is configured to engage itself in substantial correspondence of a perimeter ring 103r of the bottom portion 103, and in particular on the perimeter ring 103r that substantially develops on a plane and/or detects a transversal section greater with respect to a transversal section detected by the lateral wall 101 and/or that protrudes outwards with respect to the lateral wall 101.

As specifically shown in FIGS. 4, 5 and 6, the pusher 203 is configured to engage in substantial correspondence of the front wall 103f of the perimeter ring 103r. In the second position said pusher 203 pushes the bottom portion 103 against said striker 201, and in particular in said second position, the pusher 203 is in substantial contact with the bottom portion 103. More specifically, in said second position the pusher 203 is in substantial contact with the front wall 103f of the bottom portion 103.

The pusher 203 is configured to prevent a relative rotation between the capsule 100 for beverages and said striker 201. This takes place substantially through the development of a force axially aligned with the longitudinal axis of the capsule for beverages and/or the translation axis A, which determines—if the capsule 100 for beverages tends to rotate, a sliding friction sufficient to prevent the rotation of the capsule.

In any case, the pusher 203, or if in plurality, the plurality of pushers 203, can be provided with engagement teeth configured to engage on the body of the capsule 100 for beverages for example, but not limited thereto, in substantial correspondence of the lateral wall or of the bottom portion, specifically in substantial correspondence of the perimeter ring.

Alternatively, or in combination with the foregoing, the at least one first pusher 203, optionally each one between said first pusher and said second pusher, comprises an at least partially countershaped wall with respect to said lateral wall 101, and in the second position, the at least partially countershaped wall is positioned in substantial proximity of the lateral wall 101 of the capsule 100 for beverages.

The Applicant has observed that it can be convenient to keep track of the capsules for beverages 100 that are used, and in particular opened to release the substance. In particular, he has observed that it is possible to use electronic aids that allow to keep track of the capsules for beverages 100 that are used, in particular open.

For this reason, a preferred but non-limiting embodiment of the capsule for beverages 100 comprises at least an identification device, in particular an electronic tag and/or a radiofrequency identification circuit 119i. Such an identification device, in particular an electronic tag and/or a radiofrequency identification circuit 119i can be of the active, semi-active, semi-passive or passive type. Although, in principle, the four types of identification device, in particular an electronic tag and/or a radiofrequency identification circuit can be used equivalently, the Applicant observes that the use of an identification device, in particular an electronic tag and/or a radiofrequency identification circuit 119i of a semi-passive or passive type can be convenient in order to allow a containment of the costs of application of such an identification device, in particular an electronic tag and/or a radiofrequency identification circuit 119i on the body of the capsule. In case of an identification device, in particular an electronic tag and/or a radio frequency identification circuit 119i of the passive type, this identification device typically comprises a microchip (with a univocal identifier and eventual memory) with no power supply, an antenna and a material that acts as a physical support called ‘substrate’. A reader emits a radio signal, and this radio signal has enough energy to activate the microchip and provide it with the energy necessary to reply to the reader with a new radio transmission.

Nevertheless, some types of radio frequency identification tags are substantially flexible and their area is mostly constituted by a spiral of electrically conductive material acting as an antenna. In that case, this spiral can advantageously be wrapped around the body of the capsule for beverages.

Preferably, albeit in a non-limiting extent, therefore, the identification device, in particular an electronic tag and/or a radio frequency identification circuit 119i is irremovably, or irremovably in use, associated with the capsule 100 for beverages. This allows reducing the risk of fraud. In particular, with “irremovably” it is meant physically non-separable from the body of the capsule for beverages 100 unless destroying the body of the capsule itself. “Irremovably, in use” means that the identification device, in particular an electronic tag and/or a radiofrequency identification circuit is mounted in such a way that it can be extracted, removed or physically separated from the body of the capsule for beverages 100 only by the use of determined tools and/or only by qualified personnel.

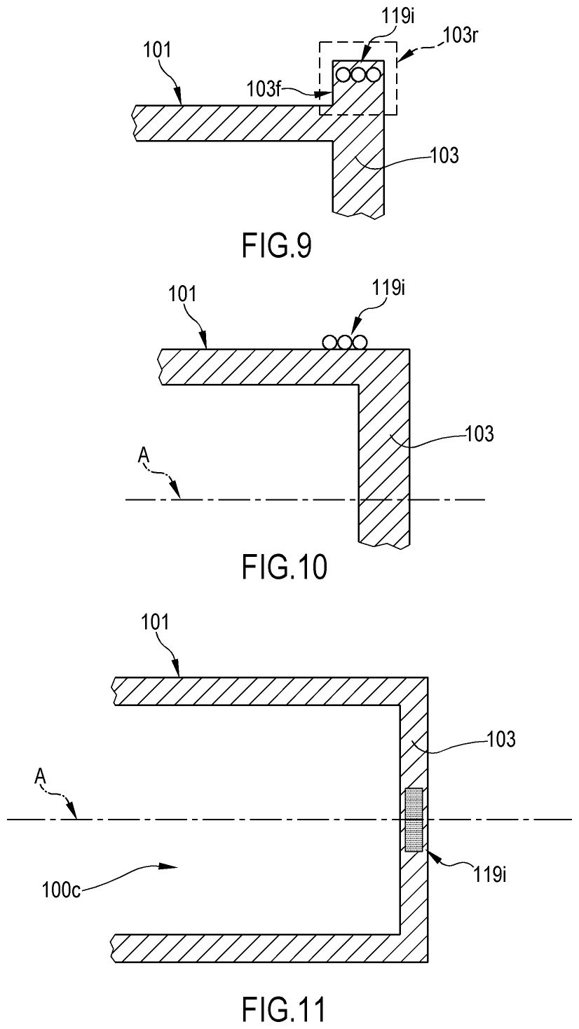

The identification device, in particular an electronic tag and/or a radiofrequency identification circuit 119i can be positioned in substantial correspondence of the lateral wall 101, optionally in substantial correspondence of an outer face of the lateral wall 101, or can be positioned in substantial correspondence of the bottom portion 103, optionally resulting introduced within the bottom portion 103. Some tag or radiofrequency circuit 119i installation configurations are shown in FIGS. 9, 10 and 11. In detail in FIG. 9 it is shown a particular embodiment wherein the identification device, in particular an electronic tag and/or a radiofrequency identification circuit 119i is positioned in substantial correspondence of the perimeter ring 103r. FIG. 9 in detail shows a section where it is possible to see that the spirals of the antenna of the tag are contained within the structure of the perimeter ring 103r, but the Applicant has conceived a further embodiment, not shown, wherein the spirals of the antenna of the radio frequency identification tag 119i are applied, for example by gluing, on the outer surface of the perimeter ring 103r, for example and in a non-limiting extent in substantial correspondence of the front part 103f or of the rear wall 103p.

FIG. 10 shows a particular embodiment, the spiral of the antenna of the radio frequency identification tag 119i is positioned in substantial correspondence of the outer face of the lateral wall 101, and is fixed thereto by gluing.

FIG. 11 shows a further embodiment, the radio frequency identification circuit 119i is embedded within the bottom portion 103 of the capsule for beverages 100.

In order to allow the identification of the capsule univocally, the identification device, in particular an electronic tag and/or a radiofrequency identification circuit 119i contains stored therein electronic data relating to the composition of said substance S and/or contains stored therein an identification code of said capsule 100 for beverages. The electronic data contained in the identification device can advantageously comprise an identification code 100z, in particular a univocal identification code and/or can comprise data concerning the production and/or filling date of the capsule 100.

The identification device, in particular the electronic tag and/or the radiofrequency identification circuit, can be installed before the filling of the capsule or after the filling of the capsule, depending on the specific configuration or operating process. Likewise, the electronic data can be stored or updated in the identification device before the filling of the capsule or after the filling of the capsule.

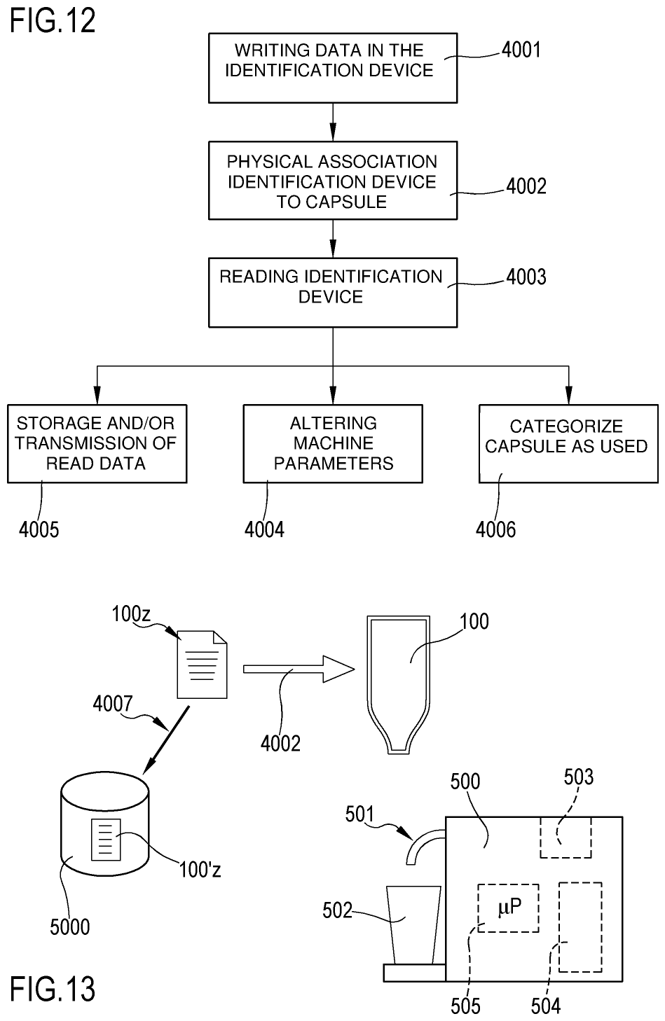

Through the use of the identification device, in particular an electronic tag and/or a radiofrequency identification circuit, it is possible to realize a method for the recording of capsules for beverages 100, which is described below with particular reference to FIGS. 12 and 13. The method of recording is realized by means of an identification device reader. The identification device reader will not be described therein, since the expert in the art will be able to construct it by means of appropriate hardware components and/or portions of software code destined to cause the execution of the method described therein. The Applicant points out that said identification code reader comprises a radiofrequency stage specifically configured and destined to allow the irradiation (or transmission) of a predefined radiofrequency signal (in particular at least a query signal) towards said identification device and also configured and destined to receive a radiofrequency signal (in particular, a reply signal) from the identification device of the capsule 100. The technology and/or protocol used for transmitting and receiving the radio signal can be, for example and not limited thereto NFC, or other standards of RFID.

The method of recording first of all comprises a step of writing (block 4001, FIG. 12) of electronic data into an identification device, in particular an electronic tag and/or a radiofrequency identification circuit 119i, wherein the electronic data contains an identification code 100z for a specific capsule 100 for beverages configured at least to identify the capsule 100 for beverages and/or a substance contained in the capsule 100 for beverages, and/or a production and/or filling date of the capsule 100 for beverages. Clearly, the step of writing (block 4001, FIG. 12) follows a step of production of the identification device, in particular of an electronic label and/or radio frequency identification circuit 119i which is not described below.

The method of recording comprises therefore a step of physical association (block 4002, FIG. 12) between the identification device, in particular an electronic tag and/or a radiofrequency identification circuit 119i and the capsule 100 for beverages. In particular, after the physical association the capsule 100 for beverages is thus effectively univocally identifiable. Such a capsule 100 for beverages can therefore be sold and/or distributed and/or given away according to the normal procedures not described as part of the state of the art.

When used, said method comprises a step of reading (block 4003, FIG. 12) of the electronic identification device, in particular an electronic tag and/or a radiofrequency identification circuit 119i associated to the capsule 100 for beverages. In particular, the step of reading (block 4003, FIG. 12) is carried out by a device for supplying the substance contained in the capsule 100 for beverages. In a preferred but non-limiting embodiment, such a device for supplying the substance contained in the capsules for beverages is a machine configured at least to mineralise water for drinking, and optionally is a machine configured to distill water, preferably but not limited thereto by means of vacuum distillation, and subsequently mineralise the water for drinking.

This method comprises, and therefore this machine is configured to carry out, a step of at least temporary storage (block 4005, FIG. 12) of at least part of the electronic data of the identification device, in particular an electronic tag and/or a radiofrequency identification circuit 119i associated to the capsule 100 for beverages after the step of reading (block 4003, FIG. 12). The storage of the data mentioned therein is destined to allow the performance of further operations, which will be described in detail below.

The method conceived by the Applicant comprises, after the at least a temporary storage (block 4005, FIG. 12) of at least part of the electronic data:
a step of transmission of at least part of the electronic data towards a remote device, which for example and not limited thereto can be a server of a company producing capsules for beverages 100, and/or producing and/or distributing the machine, and/or
a step of alteration (block 4004, FIG. 12) of the functioning parameters of the machine for supplying the beverage, according to said at least part of said electronic data, and/or according to identification code 100z and/or according to the electronic data indicating the identification of the capsule 100 for beverages and/or of the substance S contained in the capsule 100 for beverages and/or of the production and/or filling date of the capsule 100 for beverages.

Although the following list should not be intended in a limiting manner, the Applicant observes that the aforementioned functioning parameters can comprise at least one parameter from the list presented below: a supply speed of the substance S contained in the capsule 100 for beverages, a supply pressure of the substance S contained in the capsule 100 for beverages, a quantity of water, optionally distilled water, to distribute in the container 502, a temperature of the water to distribute in the container 502, an introduction of additional gases into the container 502, an introduction of flavours into the container 502.

The method can also comprise a step of electronic categorisation (block 4006, FIG. 12) of the capsule 100 for beverages as capsule 100 for beverages used and/or emptied. Preferably, the electronic categorisation of the capsules as used and/or emptied follows temporally a step of supply of the beverage in the container 502.

The present disclosure shows also a process of supply of a beverage that comprises:
a step of introduction of a capsule 100 for beverages within a machine for supplying a beverage, optionally a machine for supplying a beverage as the one therein described,
a step of opening of a capsule 100 for beverages by means of a device 300 for the opening of a capsule 100 for beverages,
a step of mixing of the substance S extracted from the capsule 100 for beverages to produce a beverage comprising a fluid additioned with said substance S,
a supply of the beverage within a container 502 for beverages by means of a dispenser 501 of the machine.

The above described process comprises the supply and/or the supply of the substance S contained in a capsule, and comprises first of all a step of electronic reading (block 4003, FIG. 12) of an identification device, in particular an electronic tag and/or a radiofrequency identification circuit 119i associated to the capsule 100 for beverages, wherein the step of reading (block 4003, FIG. 12) is carried out by a device for supplying the substance contained in the capsule 100 for beverages.

The step of reading (block 4003, FIG. 12) is aimed to allow the extraction, from the identification device, in particular an electronic tag and/or a radiofrequency identification circuit 119i, of electronic data and in particular the extraction of an identification code 100z for a specific capsule 100 for beverages. As already above described, this identification code 100z is configured to identify the capsule 100 for beverages and/or a substance contained in the capsule for beverages and/or a production and/or filling date of the capsule 100 for beverages.

The process comprises then a step of supply of said substance, comprising at least the extraction and/or an outflow of the substance from the capsule 100 for beverages. Such device for supplying the substance contained in the capsule for beverages is a machine configured at least to mineralise water for drinking, and optionally is a machine configured to distill water, preferably but not limited thereto by means of vacuum distillation, and subsequently mineralise the water for drinking. Therefore, this step of supply comprises, or causes, the production of mineralised water according to the composition of the substance extracted from the capsule 100 for beverages.

The process comprises at least a temporary storage (block 4005, FIG. 12) of at least part of the electronic data of the identification device, in particular an electronic tag and/or a radiofrequency identification circuit 119i associated to the capsule 100 for beverages after the step of reading (block 4003, FIG. 12).

The process comprises then, after the at least a temporary storage (block 4005, FIG. 12) of at least part of the electronic data, a step of transmission of at least part of the electronic data toward a remote device, which for example and not limited thereto can be a server of a company producing capsules for beverages 100, and/or producing and/or distributing the machine, and/or a step of alteration (block 4004, FIG. 12) of functioning parameters of the device for supplying said substance, more precisely of the mentioned machine, according to said at least part of said electronic data, and/or a step of electronic categorization (block 4006, FIG. 12) of the capsule 100 for beverages as a capsule 100 for beverages used and/or emptied.

The electronic categorisation (block 4006, FIG. 12) of the capsules only takes place after the supply of the beverage and/or only when the capsule has been correctly identified by means of the aforementioned reader.

As previously described, therefore, the step of physical association (block 4002, FIG. 12) is a step wherein the identification device, in particular an electronic tag and/or a radiofrequency identification circuit 119i is immovably, or immovably in use, associated to the capsule 100 for beverages. For the specific mode of physical association and relative position of the identification device, in particular an electronic tag and/or a radiofrequency identification circuit on the capsule, reference is made to the preceding portion of the description, but in general the step of physical association (block 4002, FIG. 12) comprises positioning the identification device, in particular an electronic tag and/or a radiofrequency identification circuit 119i in substantial correspondence of the lateral wall 101, optionally in substantial correspondence of an outer face of the lateral wall 101, or in substantial correspondence of the bottom portion 103, optionally by means of introduction within the bottom portion 103. In particular, the step of physical association (block 4002, FIG. 12) comprises positioning the identification device, in particular an electronic tag and/or a radiofrequency identification circuit 119i in substantial correspondence of the perimeter ring 103r of the bottom portion 103.

In the preceding portion of the description, reference was made to the alteration (block 4004, FIG. 12) of functioning parameters of the device for supplying said substance. In particular, said alteration can comprise an adjustment of an amount of water to supply into a container together with said substance when extracted from the capsule 100 for beverages. In this way, in particular, the machine previously described can automatically identify the amount of water to supply in a bottle or container without the need for any particular adjustment or intervention by the user. Thus, through the use of the identification device, in particular an electronic tag and/or a radiofrequency identification circuit described therein, it is possible to simplify the production of, for example, mineralised water with capsules for beverages 100.

Alternatively, or in combination with the foregoing, the alteration (block 4004, FIG. 12) of the functioning parameters of the device for supplying said substance can comprise an activation or deactivation of a gasifier for said water to supply together with the substance, and more in particular the activation can comprise an adjustment of a gas quantity, in particular carbon dioxide, to supply with the water. This allows to automatically adjust the machine described therein so that it is possible to realize a gasification of the water to supply to the user without the user having to be in charge of adjusting the quantity of gas per amount of water (CO₂ per litre, for example). The Applicant observes that the adjustment of the quantity of gas can be associated to the particular formulation of the substance, and in some cases, in order to allow a correct and/or complete dissolution of the substance in the water, the quantity of gas to supply and/or the quantity—especially minimum—of water within which the substance is to be introduced should not fall below a determined level.

Alternatively, or in combination with the foregoing, the alteration (block 4004, FIG. 12) of the functioning parameters of the device for supplying said substance can comprise an activation or deactivation of a mixer configured to mix the water to supply in a container with an additional fluid. This allows to produce, for example, beverages sweetened or with additional fluids such as tea, coffee, cream, alcohols, in a predetermined manner and automatically adjusted by the data contained in the identification device, in particular an electronic tag and/or a radio frequency identification circuit contained in the capsule. Thanks to this aspect, it is possible to realise cocktails or alcoholic or non-alcoholic drinks with a mineralised water of your choice in a simplified manner. This can contribute to intensify the aromaticity of the beverage or final cocktail.

Alternatively, or in combination with the foregoing, the alteration (block 4004, FIG. 12) of the functioning parameters of the device for supplying said substance can comprise an activation or deactivation of a heater or cooler for said water to supply into the container, and/or can comprise an adjustment of a supply pressure of said water to supply into the container.

With specific reference to FIG. 13, it is noted that the process described therein also comprises a step of storage (reference 4007) of a copy 100′z of said identification code 100z on an electronic database 5000.

The storage of the copy 100′z of the identification code 100z takes place in substantial correspondence of said step of writing (block 4001, FIG. 12) or in any case before a distribution of the capsules for beverages. Thanks to this aspect, the company that produces and/or distributes capsules immediately learns the data necessary to fully identify each capsule 100 for beverages, and can easily identify the presence of capsule clones.

In particular, in an embodiment, the device for supplying beverages is in fact configured to carry out a transmission of the data extracted from the identification device, in particular an electronic tag and/or a radiofrequency identification circuit 119i specifically towards the company that produces and/or distributes the capsules, in such a way that the latter can electronically compare the data received with those in the database 5000. In particular, once the capsule 100 for beverages is marked as used and/or emptied, on the device for supplying beverages and/or on the electronic database 5000 the specific identification code of the capsule is flagged, or an electronic data identifying the actual use of the capsule for beverages is attached to it. In other words, the step of electronic categorisation (block 4006, FIG. 12) of the capsule 100 for beverages as a capsule 100 for beverages used and/or emptied comprises at least a logical and/or electronic association between at least part of electronic data read object of the at least temporary storage (block 4005, FIG. 12), with a flag or data indicating the use of the capsule 100 for beverages and/or comprises the cancellation of a copy of the identification code 100z from said electronic database 5000.

If the company, or the device for the supply, receive and/or read an identification code 100z of a capsule for beverages already flagged, cancelled and/or to which has been electronically attached said indicative usage data, it will be convenient to generate and, optionally, transmit an alarm signal identifying the fact that the capsule is cloned.

In an embodiment, the device for the supply can be configured to prevent the distribution of the capsule, in particular its opening, when the step of reading (block 4003, FIG. 12) shows that the identification code 100z of the capsule corresponds to a (same) code of a previously used or emptied capsule.

The device 300 for opening capsules for beverages 100 can be advantageously coupled to a water distillation device 1 that, in a general form, comprises:
a body having a lateral wall 2 and defining a cavity suitable for allowing the distillation of an amount of water H to distill, wherein in the cavity are defined a distillation chamber 2d and a condensation chamber 2c, wherein the condensation chamber 2c comprises a collection portion 109 destined to collect at least temporarily distilled water K,
at least a heater, configured to heat the amount of water H to distill present, in use, inside the condensation chamber 2c,
a cooler, configured to determine a condensation of a distillation steam,
wherein the condensation chamber 2c comprises an outlet or through hole 2f configured to allow an outflow of the distilled water K from the collection portion 109.

In an embodiment, the body is delimited at a top by a head portion 3 and is delimited at a bottom by a bottom portion 4. Preferably, but not limited thereto, at least one between the head portion 3 and the bottom portion 4 comprises a closing element of the cavity 2c, 2d of a removable type. Specifically, the closing element allows to an operator, or at least a tool, to access the interior of the distillation chamber 2d and of the condensation chamber 2c so that they can be in use cleaned. This advantageously allows cleaning the lateral wall 2 and the other elements which are present in the cavity 2c, 2d after a determined period of use. In a non-limiting embodiment, the closing element comprises a ring that can be clamped by means of a clamp, and such ring is arranged along a plane substantially orthogonal with respect to the main axis X.

At least a support 6 is fixed to a base 5 of the water distillation device 1, in order to keep the body, in particular at least the bottom portion 4, aligned along a predetermined direction in use substantially vertical and/or in order to keep said body and in particular the bottom portion 4 spaced with respect to the base 5. In a preferred but non-limiting embodiment, the support 6 advantageously comprises at least a support column, preferably but not limited thereto realized in anodized aluminum.

In an embodiment, the water distillation device 1 object of the present disclosure comprises an inlet duct 7 for the water to distill, and an outlet duct 9 for the distilled water. The inlet duct 7 for the water to distill can be connected with a supply pump of the water H to distill.

An outlet valve 12 is configured to adjust the outflow of the water from the collection portion 109 and is in particular located downstream of the tank 11 and comprises at least an open configuration that allows the outflow of the distilled water from the tank 11, and a closed configuration that prevents the outflow of the distilled water from the tank 11.

The outlet valve 12 can be a manually controlled valve or an electronically controlled valve (solenoid valve). In an embodiment, the outlet valve can be operatively coupled to an extraction pump which is described in detail below. The outlet of valve 12, which allows the actual outflow of the distilled water K from the water distillation device 1, is indicated by the reference number 124.

Both the device 300 and the water distillation device 1 are installed into the body of the machine for supplying a beverage.

The water distillation device 1 is a vacuum distillation device configured to carry out the distillation of the water at a pressure lower with respect to the atmospheric pressure, and has an operating configuration of supply of distilled water K, within which the distilled water K collected in the collection portion 109 is made to flow in an outlet duct 10. In particular, the device 1 is configured to maintain within said cavity a predetermined vacuum level with respect to a predetermined threshold in the continuation of said operating configuration of supply of distilled water K.

In particular, the Applicant observes that if the above mentioned water distillation device 1 is provided with the inlet valve 8, during the operating configuration of supply this inlet valve 8 is kept in closed configuration.

The water distillation device 1 comprises an extraction pump connected to the outlet or through hole 2f; such extraction pump is preferably but not limited thereto configured to be activated during the operating configuration of supply to extract the distilled water K from the collection portion 109 allowing to maintain the vacuum within the cavity and/or preventing the vacuum within the cavity from exceeding a predetermined threshold value, and/or preventing, during its operation, air from entering the cavity.

In particular, the extraction pump used is an occlusive pump and/or a volumetric pump. This pump, by effect of a variation of volume within an its chamber, causes in use a suction or thrust on the distilled water K, insulates therefore the cavity, in particular the condensation chamber 2c, and therefore the collection portion, from the outer environment during its operation and when stopped. The extraction pump is configured to be activated at least during the operating configuration of supply of the distilled water K. Alternatively or in combination with the foregoing, the pump is an electro-actuated or magnetically driven pump.

In use, through the extraction pump, it is advantageously possible to supply the distilled water K necessary to produce the beverage to the device for opening capsules previously described. In general, it is therefore assertable that the water distillation device 1 described therein is configured to supply distilled water to the device for opening capsules and/or to a mixing device, for example the previously mentioned mixer 504, configured to mix the substance S extracted from the capsule 100 with the distilled water K, in order to realize the beverage.

A specific embodiment of the mixing device 504 is configured to supply at least part of the substance S extracted from the capsule 100 for beverages inside a container, in particular a bottle, for the beverage. The mixing device 504 is operatively connected with device 300 for opening capsules, in particular with the conveyor 202c.

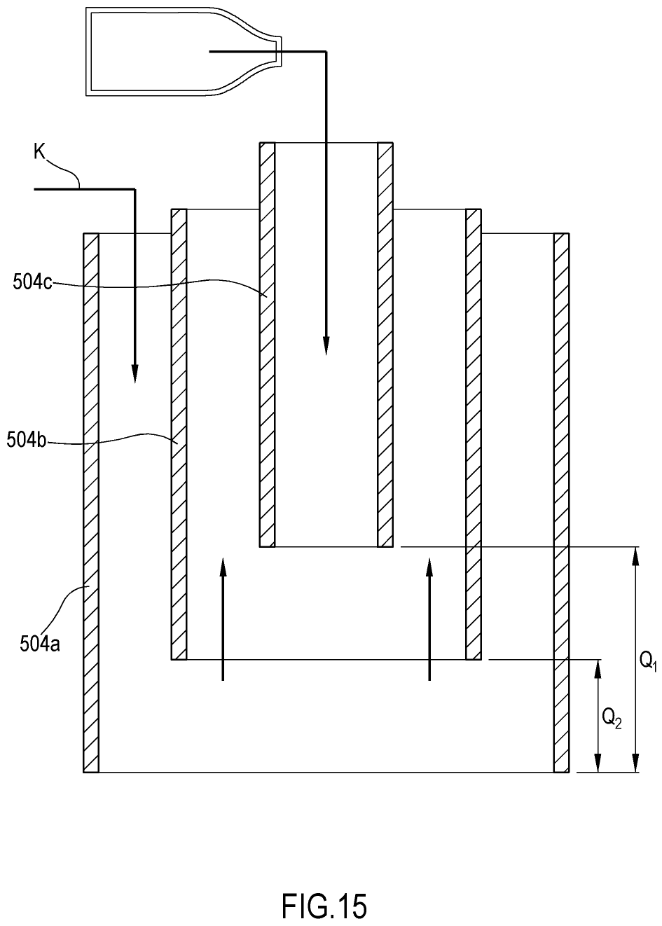

As schematically shown in FIG. 15, in an embodiment, the mixing device 504 comprises at least a first duct 504c within which, in use, flows at least part of the substance S extracted from the capsule 100 for beverages and at least a second duct 504a within which, in use, flows the distilled water K from said water distillation device 1.

The first duct 504c is operatively connected with the device 300 for opening capsules for beverages 100, and in particular is directly connected with the device 300 for opening capsules for beverages 100.

The second duct 504a is operatively connected to an outlet of the water distillation device 1 from which, in use, the distilled water K outflows; said second duct 504a being optionally directly connected to an outlet of the water distillation device 1 from which, in use, the distilled water K outflows.

In the specific embodiment shown in FIG. 15, the mixing device 504 comprises a third duct 504b. The third duct is configured to cause an extraction and/or to extract at least part of a volume of gas or air contained at least partially within the first duct 504c and/or within the second duct 504a and/or within the container, in particular the bottle, for the beverage. The above-mentioned extraction can be passive, i.e. such that the third duct 504b comprises an opening towards the outside of the machine for supplying a beverage, or it can be an active extraction. In the latter case the machine for supplying a beverage will comprise a pump or fan operatively coupled to the third duct 504b whose function is to extract said gas or air in a forced manner.

The first duct 504c and the second duct 504a are at least partially coaxial and/or the first duct 504c lies at least partially within the second duct 504a.

Preferably but not limited thereto, the third duct 504b is at least partially coaxial to the first duct 504c and/or to the second duct 504a and/or lies at least partially within the first duct 504c and/or the second duct 504a.

The first duct 504c, the second duct 504a and the third duct 504b present each one a respective first, second and third transversal section of gradually increasing size; in an embodiment, the transversal section has a substantially circular shape and therefore the diameter of the first duct 504c is lower with respect to the diameter of the second duct 504a, which is lower with respect to the diameter of the third duct 504b.

The mixing device 504 is configured to supply a predefined quantity of distilled water K within the first duct 504c together with at least part of the substance S.

In use the supply of the substance S in the container takes place through the first duct 504c, while the supply of the distilled water K, in particular in a predefined amount in relation to the capacity of the container, takes place through the second duct 504a. The distilled water K therefore flows in an annular gap defined outwardly, by the second duct 504a and internally, by the third duct 504b.

The extraction of at least part of a volume of gas or air contained at least partially into the first duct 504c and/or within the second duct 504a and/or into the container takes place in an annular gap defined outwardly by the third duct 504b and inwardly by the first duct 504c. Preferably, but not limited thereto, the extraction of the at least part of said volume of gas or air takes place simultaneously with the time interval within which the substance S is supplied through the first duct 504c and/or within which the distilled water K is supplied. Thanks to this particular concomitance of supply and extraction, it is favorably possible to avoid overloading the container with pressure. In particular, if the machine for supplying a beverage comprises the aforementioned pump or fan in operating connection with the third duct 504b, the activation of the pump or fan will take place in substantial temporal correspondence with the time interval within which the substance S is supplied through the first duct 504c and/or within which the distilled water K is supplied.

FIG. 15 shows the first duct 504c and the third duct 504b which end at a first and a second height. The first height is indicated with the reference Q1 and the second height is indicated with the reference Q2. The first height and second height Q1, Q2 are measured with respect to a relative reference given by the ending portion of the second duct 504a.

The height at which the first duct 504c ends is higher than the height at which the second duct 504a ends and is higher than the height at which the third duct 504b ends. This means that the ending portion of the first duct 504c lies still within the third duct 504b.

In use the ending portion of the second duct 504a is the one that comes into substantial contact with an upper portion of the container. Thanks to this aspect, a substantial delimitation of the volume defined by the assembly of the container and of the first duct 504c and/or of the second duct 504a is maintained.

The particular constructive realization of the mixing device 504 is such that it is configured to supply the distilled water K and the substance S along a substantially axial direction.

A particular embodiment of the mixing device 504 can comprise an element destined to cause and/or give a rotation to the flow of distilled water K and/or to the substance S such that it is determined a supply of said distilled water K and/or substance S with a vortex axially aligned to the substantially axial direction detected by the mixing device 504. Such an element can be present in at least one among the first duct 504c and/or the second duct 504a and/or the third duct 504b.

An inlet valve 8 is configured to adjust the inflow of water into the cavity. The inlet valve can be a manually controlled valve or an electronically controlled valve (solenoid valve). The inlet valve 8 comprises at least an open configuration and a closed configuration.

The Applicant in particular observes that such water distillation device 1 advantageously can comprise an intermediate or separating element J, positioned in an intermediate position of the cavity of the body, and having at least a sealing wall J′ in contact with the lateral wall 2. The intermediate or separating element J is configured to divide the cavity 2c, 2d realizing the distillation chamber 2d and the condensation chamber 2c.

In particular, the intermediate or separating element J comprises a plurality of through holes 105 configured to allow the passage of at least a distillation steam from the distillation chamber to the condensation chamber, and comprises at least a lateral wall of collection J″ joint and/or confining with the sealing wall J′. A collection portion 109 of distilled water K is comprised between the lateral wall 2 and the lateral wall of collection J″.

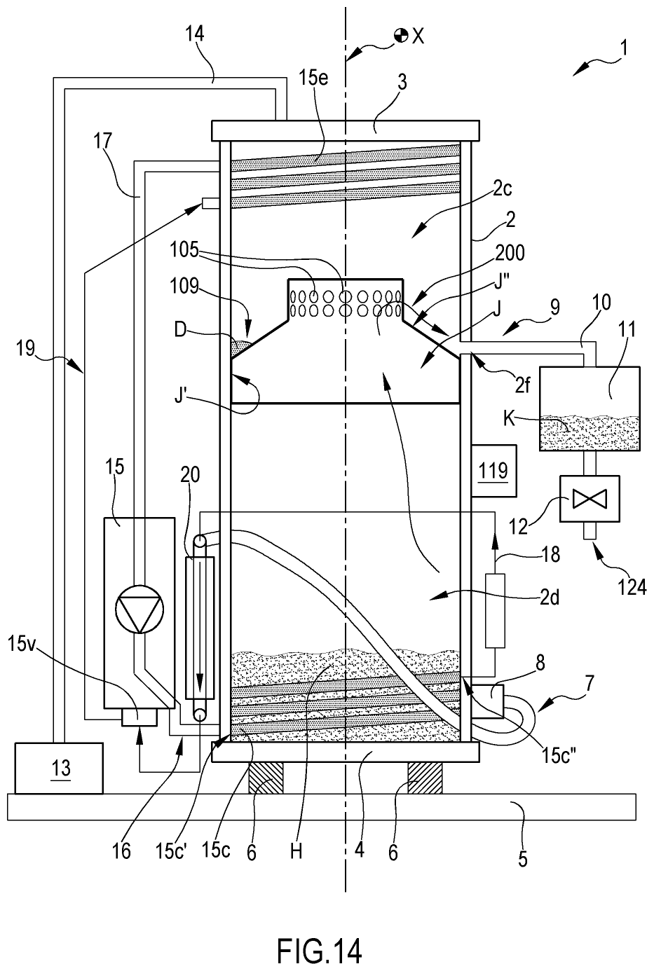

In an embodiment, that is shown in FIG. 14, the water distillation device 1 comprises a refrigerator compressor 15. This refrigerator compressor has the purpose of compressing a refrigerant gas which, when it passes through the heater 15c in the form of a refrigerator condenser, by the effect of compression, and by thermal transmission, heats the water H to distill contained, in use, in the distillation chamber. In particular, the heating of the water H to distill induced by the heater 15, in particular in the form of the refrigerator condenser, is sufficient to cause a boiling thereof.

The refrigerator circuit 15c, 15e formed by the refrigerator condenser 15c and by the refrigerator evaporator 15e (the latter realizing a particular embodiment of the previously mentioned cooler), connected to the refrigerator compressor 15, not only heats the water H to distill in the distillation chamber 2d but also cools it making it condense in the condensation chamber 2c.

The refrigerator compressor 15, preferably but not limited thereto, uses a gas which in used is passed through the heater 15c in the form of a refrigerator condenser and in a refrigerator evaporator 15e. This gas is preferably, but not limited thereto, a gas free of ozone depleting substances. In a preferred but non-limiting embodiment, this gas is propane, in particular Kryon® 290 (R-290). In an alternative embodiment to the one described above, that gas is R134a (freon, 1,1,1,2-tetrafluoroetane).

For this reason, the heater 15c is a refrigerator condenser connected to said refrigerator compressor 15. In particular, the inlet of the refrigerator condenser 15c is connected to a high-pressure outlet of the refrigerator compressor 15.

In a preferred but non-limiting embodiment, the heater 15c assumes substantially a coil shape and lies in substantial correspondence of the bottom portion of the distillation chamber. The refrigerator condenser is positioned within the distillation chamber, in particular lying substantially in correspondence of a bottom portion of the distillation chamber.

In FIG. 14 it is shown a particular embodiment of the water distillation device 1 wherein the heater 15c is positioned within the cavity 2c, 2d, and in particular within the distillation chamber. However, this configuration is not to be intended limiting, as the Applicant has conceived a particular embodiment of the water distillation device 1 wherein the heater 15c is positioned in substantial proximity to the distillation chamber but lies outside with respect to the latter. In such case at least part of the lateral wall 2 in substantial correspondence of the distillation chamber is characterized by a high thermal conductivity.

If the water distillation device 1 is operating with a refrigerator compressor 15, such water distillation device 1 will advantageously comprise a refrigerator evaporator 15e or equivalent cooler element, connected to the refrigerator compressor 15. In use, in the refrigerator evaporator 15e is present a refrigerant gas in an expanded, and therefore cooled, condition, which transfers cold to the water distillation steam, causing the condensation thereof.

In an alternative embodiment, or combined with the previous one, the refrigerator evaporator 15e can comprise, or be replaced by, an equivalent cooler comprising at least one Peltier cell, or can comprise a refrigerator evaporator 15e operatively coupled to the Peltier cell to allow the cooling of the distillation steam. The control of the Peltier cell described therein can be advantageously carried out by a data processing unit of the water distillation device 1, the functioning of which will be better described in the following portion of the description.

The refrigerator evaporator 15e is preferably but not limited thereto installed within the cavity 2c, 2d in substantial correspondence of the condensation chamber, and thus at a height not lower with respect to the height at which the intermediate or separating element J lies. In the embodiment shown in FIG. 14 the refrigerator evaporator 15e is positioned in substantial correspondence of the head portion 3 of the cavity 2c, 2d, far above the intermediate or separating element J. This configuration shall not be intended in a limiting manner, since another embodiment of the water distillation device 1 has a refrigerator evaporator 15e which is substantially aligned in correspondence of the lateral wall of the head portion of the intermediate or separating element J. In other terms, the refrigerator evaporator 15e is substantially aligned with the through holes 105 and/or lies in substantial proximity to the through holes. In this configuration, during the distillation cycle, the distillation steam of the water H to distill comes into substantial contact with the refrigerator evaporator 15e as soon as it outflows out of the plurality of through holes 105, and is therefore almost immediately condensed in the collection portion 109. This configuration allows to reduce the height, in other words the axial development, of the body of the water distillation device 1.

In this latter configuration, therefore, the refrigerator evaporator 15e assumes the shape of a substantial coil which, if observed along the direction of the main axis X, is inscribed in a shape substantially corresponding to the shape of the transversal section of the cavity 2c, 2d. In the embodiments this serpentine has a circular transversal section and has a substantially axial development aligned on the main axis X. The refrigerator evaporator 15e surrounds the head portion, in particular the lateral wall 104 of the head portion 101, of the intermediate or separating element J. It results in particular in at least partial axial alignment with the plurality of through holes 105. As it can be observed from the attached figures, between the intermediate or separating element J, in particular between the head portion of the latter, and the lateral wall 2 exists an annular portion of the condensation chamber, and the refrigerator evaporator 15e is at least partially and preferably integrally positioned in such portion of the condensation chamber. The maximum height development of the refrigerator evaporator 15e can be such that it does not exceed the maximum height reached by the intermediate or separating element J, and thanks to this aspect, the condensation chamber can have relatively reduced sizes, mainly in the axial direction with the main axis X, allowing for this reason a high level of efficiency in condensation of the distillation steam.

In another embodiment not shown in the attached figures, the refrigerator evaporator 15e is positioned in substantial correspondence of the upper portion of the lateral wall 2, in particular in substantial correspondence of the head portion 3, but lies outside of the lateral wall 2, therefore outside of the cavity. In case in which the refrigerator evaporator 15e lies outside of the lateral wall 2, in particular outside of the condensation chamber 2c, there is the need to transfer a thermal energy from the cooler element 15e to the inside of the condensation chamber 2c, in such a way that the distillation steam can be cooled, determining the production of distilled water 300 in liquid form. In such a case at least part of the lateral wall 2, in particular the part in substantial alignment with the cooler evaporator 15e, has characteristics of high thermal conductivity.

When the cooler 15e, in particular but not limited thereto when in the shape of the refrigerator evaporator 15e, lies outside of the condensation chamber 2c, this cooler can be realized according to the process described therein.

The refrigerator evaporator 15e is firstly positioned on the outside of the lateral wall, and in particular is wound in serpentine shape around the lateral wall of the condensation chamber 2c. Subsequently, the assembly formed by the refrigerator evaporator 15e and by the body of the water distillation device 1, or if in a split shape, the assembly formed by the refrigerator evaporator 15e is introduced into a shape and in that shape is cast a thermal-conductive material 2w, preferably but not limited thereto metal, and in particular aluminum. The refrigerator evaporator 15e results therefore embedded within the thermal-conductive material.

The assembly formed by the refrigerator compressor 15, by the refrigerator evaporator 15e, by the refrigerator condenser 15c and, at least, by a condenser duct 16, connected between the refrigerator compressor 15 and the refrigerator condenser 15c, and by an evaporator duct 17 connected between the refrigerator evaporator 15e and the refrigerator compressor 15, realizes a refrigerator system capable of heating water at a temperature sufficient to heat it to cause its boiling, and then causing its condensation in the condensation chamber.

The Applicant observes that although the use of a refrigerator system as described above can be applied also for non-vacuum distillation of water, in a preferred but non-limiting embodiment such a refrigerator system is more advantageous when applied to a water distillation device 1 operating under vacuum conditions, since under such conditions the boiling temperature of the water H to distill is lower with respect to the temperature necessary to cause a boiling if the water H to distill were heated at atmospheric pressure.

Preferably, but not limited thereto, the refrigerator evaporator 15e and the refrigerator condenser 15c are realized in material with low ionic release into the water, which allows a high distillation purity of the distilled water 300. In a preferred but non-limiting embodiment, such material is a metallic material and preferably is stainless steel. In a non-limiting embodiment, the outer surface of the refrigerator evaporator 15e and/or of the refrigerator condenser 15c is gold-plated.

The water distillation device 1 may comprise a pre-heater 20 for the water H to distill. In particular, the Applicant observes that the pre-heater 20 for the water H to distill described herein can be used for any type of water distillation device 1, in particular (but not limited thereto) also free from the intermediate or separating element J and/or free from the vacuum distillation function, but is preferably applicable to a water distillation device 1 provided with the heating of the water H to distill by means of a compressed fluid, as in the case of the water distillation device 1 specifically described herein, which is provided with a refrigerator compressor 15.

The pre-heater 20 is configured to pre-heat the water H to distill before its introduction into the distillation chamber 2d. The pre-heater 20 comprises a body which defines a containment vase 21, 22, 23 for the water to pre-heat, defined by:
a lateral wall 21, preferably, but not limited thereto, of tubular shape, substantially cylindrical, and with main development axial and parallel to the main axis X,
an upper wall 22,
a bottom wall 23.

Preferably, but not limited thereto, the upper wall 22 and the bottom wall 23 are orthogonal with respect to the lateral wall 21. This specific geometry is not to be intended in a limiting manner.

On the lateral wall 21 of the pre-heater 20 open an inlet duct 24 for the water to pre-heat and an outlet duct 25 for the water to pre-heat. In an alternative embodiment, the inlet duct and the outlet duct for the water to pre-heat are respectively arranged on the upper wall and the bottom wall 22, 23. In any case, the inlet duct and the outlet duct are positioned at two different heights, in order to allow in use to the water to preheat a crossing of at least part, substantially all, of the wall of the pre-heater 20.

The water distillation device 1 further comprises a vacuum pump 13, connected to an air extraction duct 14 that has access to the cavity. In a preferred but non-limiting embodiment, the air extraction duct 14 extracts air from a substantially higher portion of the cavity, and in particular accesses the cavity at a higher height with respect to the height at which substantially lies the intermediate or separating element J, thus opening onto the condensation chamber 2c.

The Applicant has developed an embodiment of the water distillation device 1 which is in particular configured to operate with a vacuum substantially equal to or lower than 150 mbar, or more preferably equal to or lower than 50 mbar, or more preferably equal to or lower than 30 mbar or even more preferably equal to or lower than 15 mbar, and to cause a heating of the water H to distill at a temperature for example and not limited thereto equal to or lower than 55° C., more in particular equal to or lower than 50° C., even more preferably equal to or lower than 47° C., more preferably equal to or lower than 45° C.

In an embodiment, that water distillation device 1 is capable of producing distilled water in a single distillation cycle with a conductivity substantially lower than 10 μS, preferably lower than 7 μS and more preferably lower or equal to 5 μS, using a refrigerator compressor consuming 75 Wh, starting from mineralized water with conductivity equal to 1200-1300 μS, with a thermal differential (ΔT), measured between the temperature of the distilled water 300 at the time of condensation and the temperature of the water 201 to distill when in the step of boiling, substantially comprised, in the interval 25° C.-45° C.

In a specific non-limiting embodiment, it has been observed that in correspondence of the cooler 15e the temperature can substantially be comprised in the interval between +12° C. and −4° C., optionally between +12° C. and −2° C., more preferably between +12° C. and 0° C., or also between +12° C. and +2° C.

The specific consumption for the water distillation device 1 according to the present disclosure can therefore be substantially equal to 75 Wh/l. The great efficiency achieved by the water distillation device 1 described here allows to produce distilled water at significantly lower costs than that traditionally produced. The Applicant observes that a specific embodiment of the device described here, particularly efficient, has a specific consumption of 50 Wh/l.

The pre-cooling system is configured to cool at least a part of the intermediate duct 18 which connects the refrigerator evaporator 15e with the refrigerator condenser 15c, and in an its general embodiment comprises an active cooler configured to remove heat from said at least a part of the intermediate duct 18. Although different types of active coolers can be used, the active cooler preferred by the Applicant is a fan 15v, in particular an electric fan. In correspondence of a first end thereof, the intermediate duct 18 is connected to the refrigerator condenser 15c, while in a second end thereof, it is connected to an auxiliary connecting duct 19 which departs from the intermediate duct 18 towards the inlet of the refrigerator evaporator 15e.

It is also observed that in particular the refrigerator condenser 15c comprises an inlet 15c′ directly supplied by the refrigerator compressor 15 and comprises an outlet 15c′ which supplies the intermediate duct 18, which is thus connected, in particular in a direct and uninterrupted manner, and in correspondence of its first end, with said outlet 15c″. A pre-expansion vase can possibly be present on the intermediate duct 18. If present, this pre-expansion vase is positioned in substantial proximity to the first end of the intermediate duct 18.

The pre-cooling system for the gases comprises a fan 15v which is placed in substantial proximity to the intermediate duct 18 that leads the gas from the outlet of the refrigerator condenser 15c to the refrigerator evaporator 15e.

In detail, the 15v fan is an axial fan and is configured to convey an air flow over at least part of the intermediate duct 18.

In a preferred but non-limiting embodiment, the fan 15v is controlled by the data processing unit; the latter carries out—preferably but not limited thereto automatically—a software routine that controls the activation or deactivation and, preferably, also the speed of rotation of the fan 15v in such a way that it is possible to adjust the air flow conveyed on the at least part of the intermediate duct 18. This advantageously allows to adjust the pre-cooling effect of the gases that are conveyed to the refrigerator evaporator 15e.

In a non-limiting embodiment, the distillation device 1 described therein comprises a tank for the distilled water, identified by numerical reference 11. The outlet duct 10 of the distilled water D is connected to the tank 11.

An outlet valve 12 is configured to adjust the outflow of water from the collection portion 109 and is in particular located downstream of the tank 11 and comprises at least an open configuration that allows the outflow of distilled water from the tank 11, and a closed configuration that prevents the outflow of distilled water from the tank 11.

The outlet valve 12 can be a manually controlled valve or an electronically controlled valve (solenoid valve). In an embodiment, the outlet valve can be operatively coupled to an extraction pump.

The Applicant observes that at least one among the intermediate or separating element J, and the body of the water distillation device, and in particular its lateral wall, can be realized in thermal-conductive material, including metal and in particular stainless steel, or can be realized in thermal-insulating material, including plastic or glass, in particular borosilicate glass.

In particular the Applicant observes that that the body of the water distillation device can be realized in a single piece or in several portions. In this latter case, a specific and non-limiting embodiment of the body of the distillation device comprises a first upper portion, integrating the head portion, and at least a second lower portion, integrating the base portion. The lateral wall extends through the first upper portion and the second lower portion. In a further embodiment, the body of the distillation device comprises a first upper portion, a second lower portion and an intermediate portion.

Preferably, the intermediate portion is interposed between the first upper portion and the second lower portion. In use, the sealing of the cavity is ensured by the presence of seals respectively positioned between the first upper portion and the intermediate portion and between the second lower portion and the intermediate portion. Thus, the first upper portion, the second lower portion and the intermediate portion are removably connectable to each other.

In this embodiment, the intermediate or separating element J is always positioned in an intermediate position of the cavity of the body globally defined through the first upper portion, the second lower portion and the intermediate portion, and has a joining portion with the lateral wall, which in this case represents the lateral wall of the first upper portion, the second lower portion and the intermediate portion. The intermediate or separating element J is configured and specifically destined to divide the cavity realizing the distillation chamber and the condensation chamber.

The intermediate or separating element J comprises at least a through hole 105 configured to allow the passage of at least a distillation steam from the distillation chamber to the condensation chamber and comprises at least a collection portion 109 of distilled water D.

In an embodiment, the intermediate or separating element J is integral with the intermediate portion of the body of the water distillation device. This should not be intended in a limiting manner, since in an alternative embodiment, the intermediate or separating element J could be integral with the first upper portion or the second lower portion of the body. In an embodiment, the intermediate or separating element J is such that the joining portion is an extension of the lateral wall 2 of the intermediate portion, in particular an uninterrupted extension of said lateral wall 2 of the intermediate portion.

In an embodiment, the through hole 105 above mentioned is a central through hole opening axially on the main axis X, and is configured to allow the passage of distillation steam from the bottom to the top in a direction substantially axial with the main axis X. The through hole 105 opens directly onto the cavity defined by the intermediate or separating element.

However, in order to prevent a risk of direct return of distillation steam from the condensation chamber 2c to the distillation chamber 2d, the Applicant has conceived an intermediate septum, which is introduced and lies in use in the cavity of the intermediate or separating element J at a lower height with respect to the height at which the through hole 105 is present. Said intermediate septum is configured to force the distillation steam into a curved path at least partially misaligned with respect to the main axis X between the distillation chamber 2d and the condensation chamber 2c. The intermediate septum is therefore configured to prevent a substantially axial path (in particular, along the main axis X) of the distillation steam between the distillation chamber 2d and the condensation chamber 2c.

In a non-limiting embodiment, the intermediate septum is realized in plastic material. This should not be intended in a limiting manner, as the intermediate septum can also be realized in metallic or glassy material, for example and in a non-limiting extent borosilicate glass.

In a preferred, but non-limiting embodiment, the intermediate septum is fixed on the lateral wall 2 of the intermediate portion of the body in correspondence of an annular recess on the inner face of the lateral wall 2.

The intermediate septum has a plurality of overlapping division planes each of which detects (or comprises) at least a passage opening for the distillation steam. The passage openings detected by two contiguous division planes are misaligned with each other in such a way to cause such a curved path 200 for the distillation steam. The division planes are parallel to each other and are substantially orthogonal to the main axis X. This specific configuration is not to be intended in a limiting manner.

The Applicant underlines that the expression “locates (or comprises)” is used because a specific embodiment of the division plane could comprise a sealing ring on the lateral wall defining the cavity of the intermediate or separating element J, wherein this sealing ring is partially occluded by the wall of the division plane, and for this reason strictly speaking the opening would actually be comprised within the division plane itself.

In an embodiment, the cavity of the intermediate or separating element J has a transversal section of circular shape tapering progressively along the main axis X between the lower portion of the intermediate or separating element J towards the upper portion of the intermediate or separating element J. With such shape of the transversal section, the division planes conveniently also show a partially circular perimeter profile, which in particular detects an incomplete circumferential sector. The perimeter profile of each of the division planes is such as to cause a contact between the division plane and the inner face of the lateral wall of the cavity of the intermediate or separating element J. Preferably, the lateral wall of the cavity substantially corresponds to the collection wall.

The division planes can be joined integrally by realizing a single piece, or they can be divided and held in a reciprocal joint configuration by means of a fastener. This fastener is preferably a screw, and is positioned in correspondence of a hole in each of the division planes. This hole is centered on the axis X.

In the specific embodiment wherein the intermediate or separating element J lies in substantial correspondence of the intermediate portion of the body, in such a case the through hole for the outflow of the distilled water from the collection portion will be realized on the lateral wall 2 in substantial correspondence of the intermediate portion. Clearly, this configuration is not to be considered as limiting, since if the intermediate or separating element J is realized in substantial correspondence of the first upper portion or of the second lower portion of the body, such a through hole will be realized in the corresponding portion.

Finally, it is clear that additions, modifications or variants, which are obvious to an expert in the art, can be applied to the object of the present disclosure without departing from the scope provided by the attached claims.

1. A device for opening capsules for beverages, the opening device comprising:
at least a perforator configured to perforate at least one between a head portion, a bottom portion or a lateral wall of the capsule for beverages, realizing an opening such as to put an inner cavity of said capsule for beverages, within which is contained a substance under pressure, in substantial communication with an outer environment,
at least a striker configured to retain the capsule for beverages in a predetermined position,
wherein
the device for opening capsules is configured to vary a relative position between the capsule for beverages and the perforator at least between a first position wherein the perforator is positioned at a distance from the capsule for beverages and a second position wherein the perforator is positioned at least partially within said capsule for beverages, protruding itself inside the inner cavity,
said device for opening capsules for beverages comprising a conveyor positioned in substantial correspondence of the perforator to realize a seal in substantial correspondence of said opening and configured to convey at least part of the substance along a predetermined direction or path of injection of the substance in a container for a beverage, such as to discharge the pressure present in the inner cavity of the capsule for beverages toward said predetermined direction or path of injection.

2. The device according to claim 1, wherein the perforator is movable between a first position wherein the perforator is positioned at a distance from the capsule for beverages and a second position wherein the perforator is positioned at least partially within said capsule for beverages, protruding into the inner cavity or, alternatively, the striker is movable between a first position such as to put the perforator at a distance from the capsule for beverages and a second position such as to put the perforator at least partially within said capsule for beverages, protruding itself inside the inner cavity.

3. The device according to claim 1, wherein the striker is substantially opposed to said perforator or wherein the striker is positioned in substantial correspondence of said perforator,
and wherein the striker extends, at least partially, along a substantially inclined plan, in particular substantially orthogonal, with respect to a line joining the first position relatively assumed between the capsule for beverages and the perforator and the second position relatively assumed between the capsule for beverages and the perforator.

4. The device according to claim 1, wherein the device for opening capsules for beverages is configured to vary a relative position between the capsule for beverages and the perforator by means of a substantially axial translation between the capsule for beverages and the perforator along a translation axis or is configured to vary a relative position between the capsule for beverages and the perforator by means of a composite roto-translation movement, said composite roto-translation movement comprising:
a substantially axial translation between la capsule for beverages and the perforator along a translation axis;
a rotation relative between the capsule for beverages and the perforator around an axis, in particular an axis substantially coincident with the translation axis.

5. The device according to claim 1, comprising at least a first pusher configured to push the capsule for beverages against said striker, and wherein:
said pusher is configured to push the bottom portion of the capsule for beverages against said striker, and wherein the pusher is movable relatively to said capsule for beverages at least between a first position of substantial disengagement with respect to the capsule for beverages and a second position of substantial engagement with the capsule for beverages, and/or
said striker is configured to engage the capsule for beverages in substantial correspondence of the bottom portion, and/or
the perforator is configured to engage the capsule for beverages in substantial correspondence of the head portion.

6. A machine for supplying a beverage, comprising:
a device for opening capsules for beverages according to claim 1;
a mixing device configured to mix a substance extracted from the capsule for beverages such that, in use, a beverage comprising a fluid added with said substance can be produced,
a dispenser for supplying the beverage within a container for beverages.

7. The machine for supplying a beverage according to claim 6, comprising a water distillation device, comprising:
a body having a lateral wall and defining a cavity suitable for allowing the distillation of an amount of water to distill, wherein in said cavity are defined a distillation chamber and a condensation chamber, wherein the condensation chamber comprises a collection portion destined to collect at least temporarily distilled water,
at least a heater, configured to heat the amount of water to distill present, in use, inside the condensation chamber,
a cooler, configured to determine a condensation of a distillation steam,
wherein the condensation chamber comprises an outlet, or through hole, configured to allow an outflow of the distilled water from the collection portion,
wherein the water distillation device is a vacuum distillation device, configured to carry out the distillation of the water at a pressure lower with respect to the atmospheric pressure.

8. The machine according to claim 6, wherein the device for opening capsules for beverages is configured to carry out the opening of a capsule for beverages comprising a lateral wall, a head portion, and a bottom portion, the head portion and the bottom portion being joined to the lateral wall, wherein said lateral wall, said head portion and said bottom portion define an inner cavity in use insulated from the outer environment and configured to contain, in use, a substance at least partially fluid and/or powdery, in particular designed to produce a beverage or an additivated liquid the substance thereof represents a determined part in weight, wherein said capsule for beverages is configured to withstand within said inner cavity a predetermined pressure produced by said substance, and wherein at least one between said head portion and/or said bottom portion and/or said lateral wall comprises an opening portion configured to be perforated by a perforator of a device for capsule opening determining an opening of the inner cavity destined to cause an outflow of the substance, said outflow being at least partially produced by the pressure within said inner cavity.

9. The machine according to claim 6, comprising an identification devices reader, configured to read an identification device of the capsule for beverages, in particular to read an electronic tag and/or a radiofrequency identification circuit of the capsule for beverages, said identification devices reader being configured to, and specifically destined to, electronically extract at least an identification code for a specific capsule for beverages from the identification device, in particular from the electronic tag and/or from the radiofrequency identification circuit and/or being configured to, and specifically destined to, identify the capsule for beverages and/or the substance contained in the capsule for beverages and/or a production and/or filling date of the capsule for beverages through said identification device.

10. The machine according to claim 9, configured to supply said beverage only when the identification devices reader has carried out the reading of the identification device of the capsule for beverages, in particular only when the identification devices reader has carried out the reading of the electronic tag and/or of the radiofrequency identification circuit of the capsule for beverages and/or when the identification devices reader has extracted the identification code for a specific capsule for beverages from the identification device and/or has identified the capsule for beverages and/or the substance contained in the capsule for beverages and/or the production and/or filling date of the capsule for beverages through said identification device.

11. The machine according to claim 9, wherein the identification codes reader is configured to carry out an at least temporary storage (4005) of at least part of the electronic data extracted from the identification device, in particular from the electronic tag and/or from the radiofrequency identification circuit (119i) and/or to carry out an at least temporary storage (4005) of the identification code (100z) for a specific capsule (100) for beverages and/or to carry out an at least temporary storage electronic data indicating the identification of the capsule (100) for beverages and/or of the substance (S) contained in the capsule (100) for beverages and/or of the production and/or filling date of the capsule (100) for beverages.

12. The machine according to claim 9, configured to alter at least a functioning parameter according to said at least part of the electronic data extracted from the identification device, and/or according to the identification code and/or according to the electronic data indicating the identification of the capsule for beverages and/or of the substance contained in the capsule for beverages and/or of the date of production and/or of filling of the capsule for beverages, and/or
configured to electronically categorize said capsule for beverages as capsule for beverages used and/or emptied after the at least temporary storage and/or after the supply of the beverage.

13. The machine according to claim 6, wherein the mixing device comprises at least a first duct within which, in use, flows at least part of the substance extracted from the capsule for beverages and at least a second duct within which, in use, flows distilled water deriving from said device for water distillation,
wherein the mixing device is operatively connected with said device for opening capsules, in particular with the conveyor,
and/or wherein the first duct is operatively connected with the device for opening capsules for beverages, and optionally is directly connected with the device for opening capsules for beverages.

14. The machine according to claim 13, wherein the mixing device comprises a third duct, said third duct being configured to cause an extraction and/or to extract at least part of a volume of gas or air contained at least partially within the first duct and/or within the second duct and/or within the container, in particular the bottle, for said beverage,
and/or wherein the first duct and the second duct are at least partially coaxial and/or wherein the first duct lies at least partially within the second duct.
